(19) United States
(12) Patent Application Publication
(10) Pub. No.: US 2012/0246094 A1
(43) Pub. Date: Sep. 27, 2012

(54) SYSTEM, METHOD & COMPUTER PROGRAM PRODUCT FOR CONSTRUCTING AN OPTIMIZED FACTOR PORTFOLIO

(75) Inventors: Jason C. Hsu, Rowland Heights, CA (US); Feifei Li, Irvine, CA (US); Omid Shakernia, Irvine, CA (US); Denis Biangolino Chaves, Newport Coast, CA (US)

(73) Assignee: Research Affiliates, LLC, Newport Beach, CA (US)

(21) Appl. No.: 13/403,899

(22) Filed: Feb. 23, 2012

Related U.S. Application Data
(60) Provisional application No. 61/446,039, filed on Feb. 24, 2011.

(51) Int. Cl. G06Q 40/06

(52) U.S. Cl. 705/36 R

(57) ABSTRACT

A system, method or computer program product for electronically constructing data indicative of an investible risk factor portfolio is disclosed. The method may include: constructing, by a processor(s), data indicative of an optimized factor portfolio, which may include: receiving data about a plurality of monthly returns for multiple years for a universe of asset classes; receiving data about investment returns; extracting a plurality of orthogonal risk factors, at least one factor characteristic, and an asset class-factor translation matrix by principal component analysis (PCA) from the data about the universe of asset classes; and optimizing to determine the optimized factor portfolio; constructing an investible custom mimicking portfolio based on the optimized factor portfolio, and any portfolio constraints, or any portfolio specifications, may include rebuilding using the asset class-factor translation matrix and an optimization process based on investment returns; and providing data indicative of the custom mimicking investible portfolio.

### CROSS-REFERENCE TO RELATED APPLICATION

This application is a U.S. Nonprovisional Application claiming the benefit of U.S. Provisional Patent Application Ser. No. 61/446,039, filed Feb. 24, 2011, of common assignee to the present invention, the contents of which are incorporated herein by reference in its entirety.

### BACKGROUND

1. Field of the Invention

The application relates generally to portfolio construction techniques and more specifically to financial object portfolio construction techniques.

2. Related Art

Various computer-implemented financial object portfolio construction systems and methods are known including such systems and methods as described in U.S. Pat. Nos. 8,005,740, 7,747,502, 7,620,577, and 7,792,719, of common assignee to the present application, the contents of all of which are incorporated herein by reference in their entirety.

What is needed is an improved computer-implemented financial object portfolio construction system and method that overcomes shortcomings of conventional solutions.

### SUMMARY

According to an exemplary embodiment of the invention, a system, method and/or computer program product may be provided setting forth various exemplary features. According to one exemplary embodiment, a system, method or computer program product for electronically constructing data indicative of an investible risk factor portfolio of financial objects may include: constructing, by at least one processor, data indicative of an optimized factor portfolio may include: receiving, by the at least one processor, data about a plurality of monthly returns for multiple years for a universe of asset classes; receiving, by the at least one processor, data about investment returns; extracting, by the at least one processor, a plurality of orthogonal risk factors, at least one factor characteristic, and an asset class-factor translation matrix by principal component analysis from the data about the universe of asset classes; and optimizing, by at least one processor, to determine the optimized factor portfolio; constructing, by the at least one processor, an investible custom mimicking portfolio based on the optimized factor portfolio, and at least one of any portfolio constraints, or any portfolio specifications, may include rebuilding using the asset class-factor translation matrix and an optimization process based on the investment returns; and providing data indicative of the custom mimicking investible portfolio.

According to one exemplary embodiment, the system, method or computer program product may be adapted where the weighting may include, electronically weighting, by the at least one processor, by a mathematical inverse of a volatility of the at least one designated factor of the plurality of risk factors to obtain the optimized factor portfolio.

According to one exemplary embodiment, the system, method or computer program product may be adapted where the weighting may include, electronically weighting, by the at least one processor, by a mathematical inverse of a square root of the variance of the at least one designated factor of the plurality of risk factors to obtain the optimal risk factor portfolio.

According to one exemplary embodiment, the system, method or computer program product may be adapted to further include electronically constructing, by the at least one computer, an investible custom mimicking portfolio based on the optimized factor portfolio.

According to one exemplary embodiment, the system, method or computer program product may be adapted where the optimizing may include, electronically optimizing further including optimizing, by the at least one computer, based on attempting to minimize aggregate portfolio risk of the optimized factor portfolio.

According to one exemplary embodiment, the system, method or computer program product may be adapted where the optimizing may include, electronically optimizing, which may include optimizing, by the at least one computer, based on at least one of: weighting by a strategy; or determining, by the at least one computer, optimal number of factors to describe the principal component analysis risk factors to obtain an optimal descriptive view may include at least one of: determining how to order factors,

determining what cut off of number of factors, determining which factor(s) are designated, or determining which factor (s) are non-designated.

According to one exemplary embodiment, the system, method or computer program product may be adapted where the optimizing may include, electronically optimizing, by the at least one computer, may include: incorporating, by the at least one computer, constraints and/or specifications may include at least one of: removing negative weightings; or minimizing tracking error.

According to one exemplary embodiment, the system, method or computer program product may be adapted where the principal component analysis may include, performing analysis electronically and decomposing, by the at least one computer, each of the plurality of asset classes into a plurality of underlying risk factors; determining factor characteristics; or determining an asset class to factor translation matrix.

According to one exemplary embodiment, the system, method or computer program product may be adapted where the optimizing may include, electronically constructing the investible portfolio further comprises: applying leverage to the investible custom mimicking portfolio to obtain a leveraged investible portfolio.

According to one exemplary embodiment, the system, method or computer program product may be adapted where the weighting may include, electronically weighting, which may include mathematically combining, by the at least one computer, at least one of: the plurality of risk factors, the at least one designated risk factor, or the any nondesignated risk factors.

According to one exemplary embodiment, the system, method or computer program product may be adapted where the mathematically combining may include at least one of: computing an average; computing a weighted average; computing a mean; or calculating a median.

According to one exemplary embodiment, the system, method or computer program product may be adapted where the process may include, electronically rebalancing the investible portfolio.

According to one exemplary embodiment, the system, method or computer program product may be adapted where the rebalancing may include rebalancing on a periodic basis.

According to one exemplary embodiment, the system, method or computer program product may be adapted where the rebalancing may include electronically rebalancing periodically, which may include at least one of: rebalancing annually; rebalancing by accounting period; rebalancing monthly; rebalancing quarterly; or rebalancing biannually.

According to one exemplary embodiment, the system, method or computer program product may be adapted where the rebalancing may include, electronically rebalancing upon reaching a threshold; rebalancing the investible portfolio as the optimal risk factor portfolio changes over time; or rebalancing the investible portfolio to match the optimal risk factor portfolio changes over time.

According to one exemplary embodiment, the system, method or computer program product may be adapted where the weighting optimizing may include, electronically weighting which may include: equally weighting across the at least one designated risk factors according to the optimal risk factor portfolio.

According to one exemplary embodiment, the system, method or computer program product may be adapted where the optimizing may include, electronically equally weighting across the any nondesignated risk factors according to the optimal risk factor portfolio.

According to one exemplary embodiment, the system, method or computer program product may be adapted where the plurality of risk factors may include at least one of: designated factors; nondesignated factors; a first group of factors; or a second group of factors.

According to one exemplary embodiment, the system, method or computer program product may be adapted to further include tagging each of the plurality of risk factors as at least one of the at least one designated factor, or the any nondesignated factors.

According to one exemplary embodiment, the system, method or computer program product may be adapted where the weighting may include, electronically mathematically combining, by the at least one computer, at least one of: the plurality of risk factors, the at least one designated risk factor, or the any nondesignated risk factors, as the risk factors change over time.

According to one exemplary embodiment, the system, method or computer program product may be adapted where the optimizing may include, electronically mathematically combining comprises at least one of: computing an average of the risk factors as the risk factors change over time; computing a weighted average of the risk factors as the risk factors change over time; computing a mean of the risk factors as the risk factors change over time; or calculating a median of the risk factors as the risk factors change over time.

According to one exemplary embodiment, the system, method or computer program product may be adapted to electronically change over time which may include changing periodically.

According to one exemplary embodiment, the system, method or computer program product may be adapted to changing periodically including at least one of: changing annually; changing by accounting period; changing monthly; changing quarterly; or changing biannually.

According to one exemplary embodiment, the system, method or computer program product may be adapted to where weighting may include weighting by risk factor parity for the plurality of risk factors.

According to one exemplary embodiment, the system, method or computer program product may be adapted to further include electronically constructing an portfolio of financial objects based on the custom mimicking portfolio.

According to one exemplary embodiment, the system, method or computer program product may be adapted to further include applying leverage to the investible portfolio to obtain a final investible risk factor portfolio.

According to one exemplary embodiment, the system, method or computer program product may be adapted to further include electronically providing investible access to particular risk factors.

According to one exemplary embodiment, the system, method or computer program product may be adapted to further include electronically constructing quantitatively an asset allocation index.

According to one exemplary embodiment, the system, method or computer program product may be adapted where electronically providing may include: publishing the asset allocation index.

According to one exemplary embodiment, the system, method or computer program product may be adapted to further include electronically constructing, by the at least one computer, at least one factor characteristic for each of the plurality of orthogonal risk factors based on the plurality of orthogonal risk factors and data about investment returns may include data indicative of characteristics may include at least one of: a plurality of investment names, an investment type, an investment country, or an investment returns by time periods, to obtain a factor structure and characteristics database.

According to one exemplary embodiment, the system, method or computer program product may be adapted to further include electronically storing, by the at least one computer, in the factor structure and characteristics database, at least one of the orthogonal factors, the factor characteristics, and the asset class-factor translation matrix.

According to one exemplary embodiment, the system, method or computer program product may be adapted to include where the asset class-factor translation matrix may include an electronic structure, which may include at least one of: a relationship between each asset class to at least one factor; a relationship of a factor to at least one asset class; dependencies between the at least one factor and the at least one asset class; or a relationship between the at least one factor and the at least one asset class.

According to one exemplary embodiment, the system, method or computer program product may be adapted to include electronically optimizing which may include at least one of: determining by the output of the factor limitations or factor specifications at least one of a designated or a non-designated, a flagged, or a non-flagged factor; taking the characteristics, ranking factors by a characteristic, specifying a cutoff point (number of factors, or characteristic level), using the factor characteristics to choose a subset of the factors, defining a criteria to include as factors in the optimization, and where a factor is included, the included factor gets assigned a weight, and if not included, the factor weight will be set to zero; defining a first group of one or more factors deemed designated factors, and if the designated factor or factors does not sufficiently meet the criterion, bringing in a minimal additional number of weights to any second group of one or more factors deemed nondesignated factor or factors, and providing an optimization process in assigning weights to any factors.

According to one exemplary embodiment, the system, method or computer program product may be adapted to include where the data indicative of the optimized factor portfolio may include: at least one designated risk factor of the plurality of orthogonal risk factors and any minimized nondesignated risk factors of the plurality of orthogonal risk factors for the each of the universe of asset classes, and an optimized weighting of the at least one designated factor and the any minimized nondesignated factors based on at least one of: factor limitations, factor specifications, factor sort logic, factor cutoffs, factor weighting logic, or factor treatment logic, etc.

According to one exemplary embodiment, the system, method or computer program product may be adapted where optimizing may include electronically weighting, by the at least one processor, by the optimized weighting of (optimal set of factors including at least one designated, and any nondesignated factors) at least one of the at least one designated risk factors, or the any minimized nondesignated risk factors to obtain an optimized factor portfolio.

According to one exemplary embodiment, the system, method or computer program product may be adapted to further include electronically at least one of: specifying asset classes for inclusion in the asset class universe; or filtering the asset classes for inclusion in the asset class universe.

According to one exemplary embodiment, the system, method or computer program product may be adapted to where the constructing an investible custom mimicking portfolio may include: obtaining for the optimized factor portfolio factors and weights, previously selected by the optimized weighting based on the underlying designated and any nondesignated factors, reducing at least one risk factor and weight associated with it, and at least one of: any portfolio constraints, or any portfolio specifications; and rebuilding an investible portfolio meeting the constraints and specifications, using the asset class-factor translation matrix.

According to one exemplary embodiment, the system, method or computer program product may be adapted to where the electronically constructing an investible custom mimicking portfolio may include wherein the investible custom mimicking portfolio is constructed may include: translating the optimized factor portfolio to an investible asset classes that has an optimal or closest fit to the portfolio constraints and/or portfolio specifications.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred exemplary embodiment is discussed below in the detailed description of the following drawings:

FIG. 1 depicts an exemplary flow diagram illustrating an exemplary embodiment of an exemplary hardware system and matrix executing an exemplary database system and methodology according to an embodiment of the present invention;

FIG. 2A depicts another exemplary flow diagram illustrating an exemplary embodiment of an exemplary hardware system and network coupling various exemplary subsystems and illustrating a matrix of factors executing an exemplary database system and methodology according to an embodiment of the present invention;

FIG. 2B depicts yet another exemplary flow diagram illustrating an exemplary embodiment of an exemplary hardware system and network coupling various exemplary subsystems and illustrating a matrix of factors executing an exemplary database system and methodology according to an embodiment of the present invention;

FIG. 3 depicts an exemplary diagram illustrating an exemplary principle component analysis output illustrating a long tail of exemplary risk factor components of an exemplary embodiment of the present invention;

FIGS. 4A, 4B, and 4C, respectively, depict exemplary flow diagrams illustrating an exemplary risk factor analysis process based on accessing data; exemplary methodology of constructing data indicative of a portfolio based on an optimized factor portfolio; and an exemplary methodology of extracting factors and constructing factor characteristics to obtain an optimized factor portfolio, of exemplary embodiments of the present invention;

FIG. 5 depicts an exemplary diagram illustrating an exemplary processor-based computer system as may be used as various subsystem hardware components of FIG. 2 of an exemplary embodiment of the present invention;

FIG. 6A depicts an exemplary diagram illustrating an exemplary graphing of percentages of total variance against various financial object or asset types for an exemplary risk parity allocation, of an exemplary embodiment of the present invention;

FIG. 6B depicts an exemplary diagram illustrating an exemplary graphing of percentages of total variance against various financial object or asset types for an exemplary equal weighting allocation, of an exemplary embodiment of the present invention;

FIG. 6C depicts an exemplary diagram illustrating an exemplary graphing of percentages of total variance against various financial object or asset types for an exemplary minimum variance allocation, of an exemplary embodiment of the present invention;

FIG. 6D depicts an exemplary diagram illustrating an exemplary graphing of percentages of total variance against various financial object or asset types for an exemplary mean-variance optimal allocation, of an exemplary embodiment of the present invention;

FIG. 7A depicts an exemplary diagram illustrating an exemplary graphing of portfolio weight of various financial object classes or asset types for an exemplary risk parity allocation, over time of an exemplary embodiment of the present invention;

FIG. 7B depicts an exemplary diagram illustrating an exemplary graphing of portfolio weight of various financial object or asset types for an exemplary equal weighting allocation, over time of an exemplary embodiment of the present invention;

FIG. 7C depicts an exemplary diagram illustrating an exemplary graphing of portfolio weight of various financial object or asset types for an exemplary minimum variance allocation, over time of an exemplary embodiment of the present invention;

FIG. 7D depicts an exemplary diagram illustrating an exemplary graphing of portfolio weight of various financial object or asset types for an exemplary tangency, over time of an exemplary embodiment of the present invention;

FIG. 8A depicts an exemplary diagram illustrating an exemplary graphing of various risk factors graphed against exemplary percentages of exemplary total variance explained by each exemplary risk factor asset types of an exemplary embodiment of the present invention; and

FIG. 8B depicts an exemplary diagram illustrating an exemplary graphing of various exemplary asset loadings of an exemplary first three factors for each of the financial object or asset classes of various exemplary risk factors and exemplary asset types of an exemplary embodiment of the present invention.

### DETAILED DESCRIPTION OF VARIOUS EXEMPLARY EMBODIMENTS OF THE PRESENT INVENTION

### Introduction to Risk Parity

The reader is directed to the following background literature for further explanations discussed herein.
Bhansali, Vineer. “Beyond Risk Parity.” Journal of Investing 20, no. 1 (Spring 2011): 137-147.
Chaves, Denis B., Jason C. Hsu, Feifei Li, and Omid Shakernia. “Risk Parity Portfolio Vs. Other Asset Allocation Heuristic Portfolios.” Journal of Investing 20, no. 1 (Spring 2011): 108-118.
Chow, Tzee-man, Jason C. Hsu, Vitali Kalesnik, and Bryce Little. “A Survey of Alternative Equity Index Strategies.” Research Affiliates Working Paper, 2010.
DeMiguel, Victor, Lorenzo Garlappi, and Raman Uppal. “Optimal Versus Naive Diversification: How Inefficient is the 1/N Portfolio Strategy?” Review of Financial Studies 22, no. 5 (May 2009): 1915-1953.
Fama, Eugene F., and Kenneth R. Fench. “Industry Costs of Equity.” Journal of Financial Economics 43, no. 2 (February 1997): 153-193.
Inker, Ben. “The Dangers of Risk Parity.” Journal of Investing 20, no. 1 (Spring 2011): 90-98.
Jobson, J. D., and Bob Korkie. “Putting Markowitz Theory to Work.” Journal of Portfolio Management 7, no. 4 (Summer 1981): 70-74.
Ledoit, Olivier, and Michael Wolf. “Improved Estimation of the Covariance Matrix of Stock Returns With an Application to Portfolio Selection.” Journal of Empirical Finance 10, no. 5 (December 2003): 603-621.
Lintner, John. “The Valuation of Risk Assets and the Selection of Risky Investments In Stock Portfolios and Capital Budgets.” Review of Economics and Statistics 47, no. 1 (February 1965): 13-37.
Litterman, Robert, and Jose Scheinkman. “Common Factors Affecting Bond Returns.” Journal of Fixed Income 1 (1991): 54-61.
Maillard, Sébastien, Thierry Roncalli, and Jêrôme Teïletche. “The Properties of Equally Weighted Risk Contribution Portfolios.” Journal of Portfolio Management 36, no. 4 (Summer 2010): 60-70.
Markowitz, Harry. “Portfolio Selection.” Journal of Finance 7, no. 1 (March 1952): 77-91.
Merton, Robert C. “An Intertemporal Capital Asset Pricing Model.” Econometrica 41, no. 5 (September 1973): 867-887.
Merton, Robert C. “On Estimating the Expected Return on the Market: An Exploratory Investigation.” Journal of Financial Economics 8, no. 4 (December 1980): 323-361.
Michaud, Richard. “The Markowitz Optimization Enigma: Is ‘Optimized’ Optimal?” Financial Analysts Journal 45, no. 1 (January/February 1989): 31-42.
Qian, Edward. “On The Financial Interpretation of Risk Contribution: Risk Budgets Do Add Up.” Journal of Investment Management 4, no. 4 (2006): 41-51.
Roll, Richard. “A Critique of the Asset Pricing Theory's Tests Part I: On Past And Potential Testability of the Theory.” Journal of Financial Economics 4, no. 2 (March 1977): 129-176.
Ross, Stephen A. “The Arbitrage Theory of Capital Asset Pricing.” Journal of Economic Theory 13 (December 1976): 341-360.
Ruban, Oleg, and Dimitris Melas. “Constructing Risk Parity Portfolios: Rebalance, Leverage, or Both?” Journal of Investing 20, no. 1 (Spring 2011): 99-107.
Sharpe, William F. “Capital Asset Prices: A Theory of Market Equilibrium under Conditions of Risk.” Journal of Finance 19, no. 3 (September 1964): 425-42.

### Traditional Asset Allocation Framework

Traditional strategic asset allocation theory is deeply rooted in the mean-variance portfolio optimization framework developed by Markowitz (1952) for constructing equity portfolios. However, the mean-variance optimization methodology is difficult to implement due to the challenges associated with estimating the expected returns and covariances for asset classes with accuracy. Subjective estimates on forward returns and risks can often be influenced by behavioral biases of the investor, such as over-estimating expected returns due to the recent strong performance of an asset class or under-estimating risk due to personal familiarity with an asset class. Empirical estimates based on historical data are often far too noisy to be useful, especially if risk premia and correlations for asset classes are time-varying. See Merton (1980) for a discussion on the impact of time-varying volatility on the estimate for expected returns. See Cochrane (2005) for a survey discussion on time-varying equity premium and models for forecasting equity returns. See Campbell (1995) for a survey on time-varying bond premium. See Hansen and Hodrick (1980) and Fama (1984) for evidence on time-varying currency returns. See Bollerslev, Engle and Wooldridge (1987) and Engle, Lilien and Robins (1987) for evidence on time-varying volatility in equity and bond markets. Additionally, the possibility of “paradigm shift” in the capital market makes historical data far less relevant for forecasting the future evolution of asset returns. This last concern is especially relevant today given the hypothesis on a “new normal” for the global economy postulated by Gross (2009).

The challenges in the implementation of Markowitz's portfolio optimization have led to a wide gap between the theory of the practice and the practice of the theory. See Michaud (1989) and Chopra and Ziemba (1993) for discussions on problems with using the mean-variance optimization methodology for construction portfolios. In practice, institutional pension portfolios largely take on a 60/40 equity/bond allocation, with alternative asset classes, at the margin, garnering only modest weights. It is unlikely that this portfolio posture falls out of an exercise in constrained portfolio mean-variance optimization; rather it is a hybrid child of legacy portfolio practice and return targeting. (Using 9.0% and 6.5% as expected stock and bond returns respectively, the mean-variance optimal portfolio would invest 9.3% in stocks and 90.7% in bonds; which would produce a portfolio with a Sharpe Ratio of 0.67. The 60/40 equity/bond portfolio, by comparison, has a Sharpe Ratio of 0.41.) Using historical realized risk premia to guide our capital market return expectations, assuming a 9.0% equity return and a 6.5% bond returns, the 60/40 portfolio conveniently achieves the 8% portfolio return target that is common to most pension funds. As more asset classes, such as real estate, commodities, and emerging market securities, are added to the investment universe, weights are reallocated from stocks and bonds modestly to these alternative assets. Largely, most pension funds hold a 60/40 equity/bond variant portfolio despite the significantly larger universe of investable asset classes. Without doubts, these incremental allocations improve portfolio mean-variance efficiency by improving diversification; however it is also likely that more optimal asset allocation methods or heuristics can be created.

### Risk Parity Argument

Empirically, the risk (variance) of the traditional 60/40 equity/bond portfolio variants is dominated by the equity market risk, since stock market volatility is significantly larger than bond market volatility. Additionally, at the margin, the allocations to alternative asset classes are too small to contribute meaningfully to the portfolio risk. In this sense, a 60/40 portfolio variant earns much of its return from exposure to equity risk and little from other sources of risk, making this portfolio approach under-diversified in its risk exposure.

Proponents of the Risk Parity approach argue that a more efficient approach to asset allocation is to equally weigh the asset class by its risk (volatility) contribution to the portfolio. This essentially allocates the same volatility risk budget to each asset class; that is, under the Risk Parity weighting scheme, each asset class contributes approximately the same expected fluctuation in the dollar value of the portfolio. Theoretically, if all asset classes have roughly the same Sharpe Ratios and same correlations, Risk Parity weighting could be interpreted as optimal under the Markowitz framework. For an exact mathematical proof for this statement, see Maillard, Roncalli and Teïletche (2010). There is no official definition for the Risk Parity methodology; product providers use varying definitions of “risk contribution” and different assumptions on the joint distributions for asset classes; many even model the joint distributions as time-varying. In the two assets case, all interpretation would roughly lead to the same portfolio, which is one that is simply weighted by the inverse of the portfolio volatility. In the multi-asset case, the portfolio constructions can differ very significantly and (time-varying) correlation assumptions between assets can play a critical role. A simplified Risk Parity approach that has anchored the practice of some of the biggest players in this space is weighting by inverse asset class volatility. See Maillard, Roncalli and Teïletche (2010) for details on one reasonable execution of the risk parity portfolio concept-equally-weighted risk contribution portfolio; this methodology includes as a special case the inverse volatility weighted risk parity portfolio. Also see Qian (2005,2009) and Peters (2009), which are product provider whitepapers providing discussions on their respective Risk Parity strategies. Bridgewater promotes a version of risk parity which only focuses on the volatility and ignores the correlation information (or assumes a special case of constant correlation for assets), which produces one of the simplest risk parity methodologies; in our paper, we adopt this simpler portfolio construction. We believe that the qualitative conclusions are robust to the exact specification of the Risk Parity methodology. Regardless of the exact approach, the Risk Parity portfolio generally is fixed-income heavy, which results in lower portfolio volatility and returns. Investors can then target the desired portfolio expected return by levering up the portfolio.

The strategy, of course, has its critics. Inker (2010) questions whether asset classes like commodities and government bonds provide a positive risk premium over cash in the long run; in the absence of risk premium for a number of the asset classes included for investment, the Risk Parity approach would result in very a sub-optimal portfolio. Levell (2010) and Foresti and Rush (2010) point out that leveraging introduces new risks into the investor portfolio such as variability in financing costs and availability of financing; it also amplifies the impact of tail events like liquidity crisis on the investor portfolio. In a recent research report, Meketa Investment Group, a U.S. based institutional asset consultant, highlight these very same risks to its clients.

In Table 1, we show the historical return of the 60/40 S&P500/BarCap Agg portfolio vs. a Risk Parity portfolio constructed from the same two assets. From a Sharpe Ratio perspective, the Risk Parity construction does appear to be superior. While the unlevered Risk Parity portfolio has a lower return, it can be levered up to the same volatility as the 60/40 portfolio to provide a better return than 60/40. We note that our data sample (1980-2010) coincides with a period of declining interest rates which is favorable to the Risk Parity portfolio. We'd expect that the performance of the Risk Parity strategy would be somewhat degraded during rising interest rates. Furthermore, by performing sub-sample analysis we see that the results can be highly dependent on sample period.

A major benefit of Risk Parity weighting over mean-variance optimization is that investors do not need to formulate expected return assumptions to form portfolios. The only input that needs to be supplied is asset class covariances, which usually can be estimated more accurately than expected returns using historical data (Merton (1980)). Certainly, the covariance estimates can have an impact on portfolio allocation; however, it is unclear whether poor quality covariance estimates would bias the resulting portfolio returns downward.

When compared against asset allocation products (whether tactical or strategic, qualitative or quantitative) which are heavily focused on forecasting capital market returns, the Risk Parity portfolio heuristic may be considered more transparent and mechanical, which mitigates the risk of behavioral biases influencing asset allocation decisions. However, we do note that the commercial products generally can and do involve some (if not significant) manager discretion and that the exact method for measuring risk contribution and allocating the risk budget may not be fully disclosed. A recent report by Hammond Associates concludes, with regard to the managed commercial products, that “ . . . there appears to be a lot of art involved.”

### Other Compelling Portfolio Heuristics

Risk Parity weighting is, of course, not the only alternative asset allocation heuristic to the 60/40 equity/bond portfolio. In this paper we also consider two additional asset allocation strategies which are more tractable than the Markowitz mean-variance optimization strategy and offer better risk premium diversification than the 60/40 equity/bond strategy. Maillard, Roncalli and Teïletche (2010) also consider a horse race between risk parity, equal weighting and minimum variance. They use a different universe of assets and a shorter time period (1995-2008) whereas our data covered (1980-2010) and found different performance order ranking. We reference their results in a later section to arrive at a conclusion regarding the robustness of the risk parity in-sample outperformance.

Equal weighting—One of the most naïve portfolio heuristics is equal weighting. Investors do not need to assume any knowledge regarding the distribution of the asset class returns. The equally weighted portfolio is mean-variance optimal only if asset classes have the same expected returns and covariances. This strategy, empirically, provides superior portfolio returns when applied to the U.S. and global equity portfolio construction. See DeMiguel, Garlappi and Uppall (2009) and Chow, Hsu, Kalesnik and Little (2010).

Minimum variance—Another popular approach for constructing equity portfolios without using expected stock return information is the minimum variance approach. The approach utilizes the covariance information but ignores expected returns information. Covariances can also be estimated with higher degree of accuracy using historical data (Merton (1980)) than expected returns; the minimum variance methodology therefore focuses on extracting information which can be extracted with some accuracy from the historical asset return data. Note that the minimum variance portfolio is mean-variance optimal only if asset classes have the same expected returns. Again, the minimum variance strategy has demonstrated success when applied to equity portfolio construction. See Chopra and Ziemba (1993), Clarke and de Silva and Thorley (2006) and Chow, Hsu, Kalesnik and Little (2010). Chopra and Ziemba (1993) show that, for stocks, the stark assumption that all stock returns are equal, can actually result in a better portfolio than formulating an optimal portfolio based on noisy stock return forecasts.

### A Horserace Between Risk Parity and Other Asset Allocation Strategies

In this section we compare the Risk Parity strategy against other asset allocation strategies. In this horserace, we consider equal weighting, minimum variance, and a naïve mean-variance optimization, in addition to two variants of the 60/40 portfolio. The universe of investible asset classes includes long term U.S. Treasury, U.S. investment grade bonds, global bonds, U.S. high yield bonds, U.S. equities, international equities, emerging market equities, commodities and listed real estates. These asset classes are represented by the following investable indexes, respectively: BarCap U.S Long Treasury Index, BarCap U.S. Investment Grade Corporate Bond Index, JP Morgan Global Gov't Bond Index, BarCap U.S. High Yield Corporate Bond Index, S&P500 Index, MSCI EAFE Index, MSCI Emerging Market Index, Dow Jones UBS Commodity Index and FTSE NAREIT US Real Estate Index.

For the mean-variance optimized strategy, we use the average return from the past 5 years as a forecast for future asset class returns. We also use the monthly data from the past 5 years in conjunction with a standard shrinkage technique to estimate the covariance matrix. See Clarke and de Silva and Thorley (2006). The same covariance matrix is also used to construct the minimum variance portfolio. We also construct a model U.S. pension portfolio with a 60/40 anchor, comprising 55% stocks (80% U.S. and 20% International), 35% bonds (60% U.S. Long Treasury, 20% investment grade corporate and 20% global bonds) and 10% alternative investments (2.5% each commodities, REITs, emerging market equities and high yield bonds). All strategies are rebalanced annually and are long only portfolios. The no-shorting constraint on the Minimum Variance and Mean-Variance Optimal strategies is necessary for an apples-to-apples comparison, since both Equal Weighting and Risk Parity Weighting implicitly start with no shorting. The weights in the mean-variance optimal strategy are constrained to less than 33% to avoid extreme allocations.

We simulate portfolio returns using asset class return data from 1980 through June 2010. The constructions are such that there are no look-ahead and survivorship biases. Note that prior to 1989, the high yield index does not exist; prior to 1993 the EM equity index does not exist. We simply omit those asset classes in the portfolio construction prior to their existence. We report the performance of the asset allocation strategies in Table 2. Admittedly, our choice of annual rebalancing is an arbitrary one—we would expect the Sharpe Ratios to decrease slightly with more frequent rebalancing due to asset class momentum effect. With monthly rebalancing, the Sharpe Ratios for the 60/40, US Pension, Risk Parity, Equal Weighting, Minimum Variance, and Mean-Variance Optimal portfolio strategies are 0.52, 0.50, 0.50, 0.47, 0.24, and 0.46 respectively. By comparing strategies according to their respective Sharpe Ratios, we are implicitly assuming that investors will use leverage to achieve a required rate of return. We used Bootstrap Resampling to compute standard errors and compute t-tests of the differences of Sharpe Ratios. As one would expect given the similarity of the Sharpe Ratios, none of strategies' Sharpe Ratios were statistically significantly different from each other. The time series of portfolio weights are reported in the appendix.

### Discussion

Similar to previous findings based on U.S. and global equities, the mean-variance optimal approach underperforms the non-optimal strategies in out-of-sample horseraces, giving support to the claim that with noisy inputs, optimized portfolio strategies are not necessarily optimal (Michaud (1989)). The mean-variance optimized portfolio based on 5-year historical averages has a relatively low Sharpe Ratios of 0.43, contrary to the objective of the methodology, which is to have the highest attainable Sharpe Ratio. Using recent asset class performance leads the mean-variance optimizer to allocate aggressively to asset classes with high past 5-year returns and/or low past 5-year risk. However, this approach results in significantly lower risk adjusted future returns and seems to suggest mean-reversion in asset class returns. See De Bondt and Thaler (1985) for evidence on equity market mean-reversion and Asness, Moskowitz and Pedersen (2009) for evidence on mean-reversion for various asset classes. The second optimization approach, minimum variance, also produces disappointing results. Although it achieves its objective of producing a low-volatility portfolio, its Sharpe Ratio, which is the lowest of all, is only 0.24.

As expected, the Risk Parity strategy favors more of the lower risk asset classes, resulting in one of the lowest portfolio volatilities; only the minimum-variance portfolio has a lower volatility. However, unlike our initial example in Table 1 (and what is referenced in most studies on the Risk Parity strategy), the Sharpe Ratio of the more diversified and comprehensive Risk Parity portfolio is not higher than the 60/40 portfolio variants, or a simple equal weighting of the 9 asset classes. Additionally, note that when these portfolios are levered up to achieve the same 5.1% excess return of the 60/40 benchmark, it is unclear whether their Sharpe Ratios would remain the same after financing costs. More interestingly, the Sharpe Ratio for the stock/bond Risk Parity portfolio in Table 1 is higher than the Sharpe Ratio for the, arguably, more diversified 9 asset class Risk Parity portfolio (0.62 vs. 0.51). This calls into question the robustness of the methodology's performance advantage noted in different studies. We also compare our results to a different horserace performed by Maillard, Roncalli and Teïletche (2010), which study portfolio constructed from different asset classes and over a shorter horizon (1995-2008). They report the highest Sharpe Ratio for their Risk Parity portfolio followed by minimum variance with equal-weighting coming in last. This further substantiate one of the key messages in our paper—that the observed Risk Parity performance characteristics relative to other asset allocation alternatives can be highly dependent on time period and asset classes included.

In Table 3, we take a closer look at the robustness of the strategies by computing the sub-period Sharpe Ratios for each decade since 1980. We see that the 60/40 strategy had a full sample Sharpe Ratio of 0.50. However the Sharpe Ratio during the 1990's was nearly twice that at 0.99 and was only 0.04 during the 2000's; the 60/40 portfolio experience was dominated by the equity market performance, despite the massive bond market rally in the 2000's. The Sharpe Ratios for the equal weighting and the Risk Parity portfolios have been comparably more stable over the last three decades than the other strategies. This suggests that the full-sample Sharpe Ratio for the Risk Parity or equal weighting would be good predictor of strategy performance for the next 10-year; whereas the full-sample Sharpe Ratio for the 60/40 benchmark, minimum variance, or the mean-variance optimal portfolio would not predict future strategy performance with high accuracy.

We now turn our attention to one of the claims by Risk Parity proponents, which is that the strategy provides true diversification by allocating risk equally across asset classes. To evaluate if that is indeed the case, for each strategy we compute the percentage of the ex-post total portfolio variance attributed to each asset class. Since the portfolio return can be decomposed to the weighted asset class returns, rₚ=Σᵢ₌₁^{N}wᵢrᵢ, the portfolio's total variance can be decomposed into sums of covariances of the weighted returns. Thus, the ex-post risk allocation for each asset class is

$$Risk Allocation to {Asset}_{i} = \frac{{\sum }_{i = 1}^{N} cov ( {w}_{i} {r}_{t} , {w}_{1} r {\text{?}}_{} )}{var ( {r}_{\text{?}} )}$$

$$\text{?} \text{indicates text missing or illegible when filed}$$

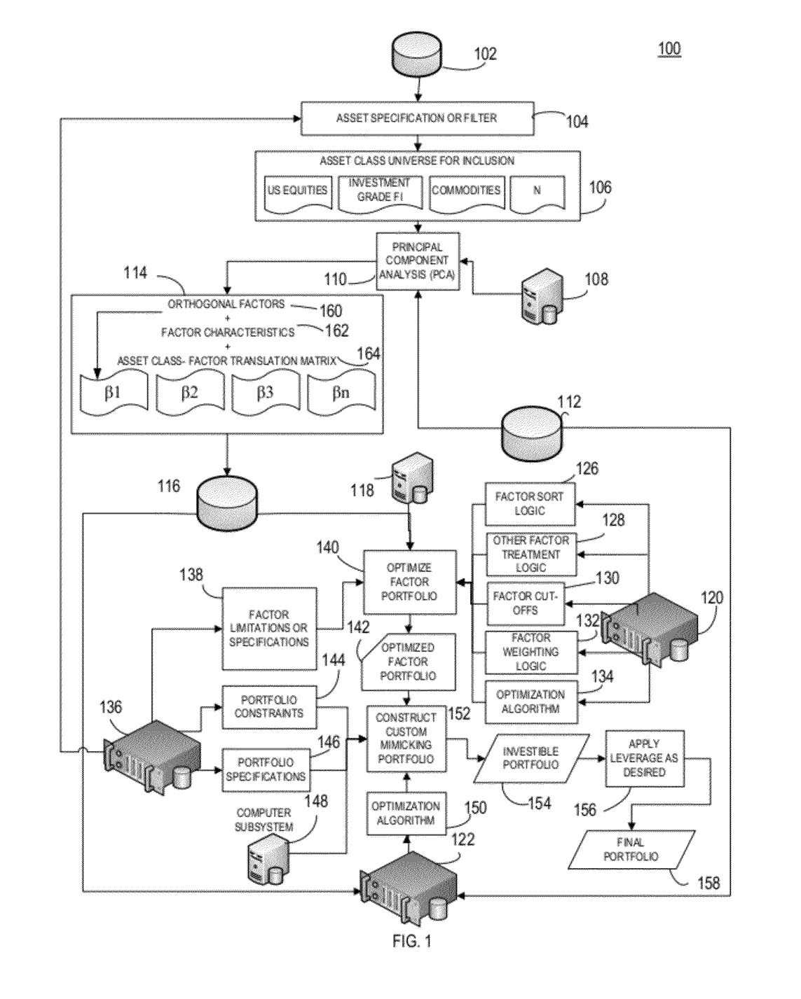

FIG. 1 shows the percentage of ex-post total variance attributed to each asset class for the portfolio strategies under consideration. Although the risk allocation for the Risk Parity portfolio is not exactly equal across asset classes, ex post, it is indeed much more balanced than the other strategies. Notice that the equal weighting portfolio has a higher risk allocation to the riskiest asset classes. Since those risky assets typically demand a higher risk premium, the mean-variance optimal strategy also tends to have more risk allocation to the riskiest assets; hence the equal weighting and the mean-variance optimal portfolio look quite similar in terms of risk allocation. At the other extreme, we see that the minimum variance portfolio puts the bulk of its risk allocation in less volatile bonds.

### Sensitivity to Asset Class Universe

Comparing the performance of the Risk Parity portfolios in Tables 1 and 2, we find that the performance of the strategy can highly dependent on the universe of asset classes we include. Which asset classes and how many to include can be an art with the Risk Parity strategy (as would be the case with equal weighting). The sensitivity to asset class inclusion can also bring to question the validity of the documented superior empirical performance. The very act of selecting asset classes for the Risk Parity portfolio construction can add elements of data mining and look ahead bias into the empirical research.

We illustrate the sensitivity to the asset class inclusion decision in Tables 4 and 5a,b. Specifically, in Table 4 we reduce the number of asset classes from 9 down to 5, keeping only U.S. Long Treasury, U.S. Investment Grade Corporate, S&P500, Commodities and REITS. For the 5 asset class scenario, the Sharpe Ratios for both the Risk Parity and the equal weighting strategies drop from 0.51 to 0.45 in the full sample. In Table 5a and 5b we add one new index into the original 9 asset class and the 5 asset class universe of investments—the BarCap Aggregate Bond Index, an index that is largely invested in intermediate term U.S. Treasuries. This is not a special asset, except that it has had one of the best historical Sharpe Ratios (0.82), producing 7.3% return with 4% volatility in the last years. The BarCap Aggregate is also the driver of the impressive Sharpe Ratio (0.62) for the stock/bond Risk Parity portfolio reported in Table 1; the S&P500/BarCap Agg Risk Parity portfolio, on average, invests 80% of the portfolio in the BarCap Agg index. The inclusion of this low risk bond index results in an improvement in Sharpe Ratios for both the equal weighting and Risk Parity methodology (from 0.51 to 0.54 for the 9 asset class case and from 0.45 to 0.50 in the 5 asset class case). Furthermore, this difference is especially pronounced in the last decade. For shorter horizon studies, the last decade would have disproportional influence on the empirical result. Investors should apply caution when examining the empirical benefit of leveraging up a fixed-income heavy Risk Parity portfolio.

Table 4 and Table 5a,b suggest that, perhaps, including more asset classes produces better Risk Parity portfolios. However, this is not generally the case. The two asset class (S&P500/BarCap Agg) Risk Parity portfolio has a significantly better Sharpe Ratio than the 10 asset class (9+BarCap Agg) Risk Parity portfolio (0.62 vs. 0.54). Also the 9 asset class Risk Parity portfolio has only insignificant performance advantage over the 6 asset class (5+BarCap Agg) Risk Parity portfolio (0.51 vs. 0.50). Further research is required to deduce a general relationship between the number of asset classes to include and the resulting Risk Parity portfolio performance.

Thus, Risk Parity is an investment strategy that has attracted significant attention in recent years. We show that this strategy has a higher Sharpe Ratio than well established approaches like minimum variance or mean-variance optimization, but it does not consistently outperform a simple equal weighted portfolio or even a 60/40 equity/bond portfolio. It does have some interesting characteristics such as a balanced risk allocation and less volatile performance characteristics (Sharpe Ratios) over time. However, we also find that Risk Parity is very sensitive to the inclusion decision for assets. The methodology is mute on how many asset classes and what asset classes to include. This last point is particularly problematic because there are little in ways of theory to guide the asset inclusion decision. It is not the case that including more asset classes leads to better portfolio results. Empirically, we also know that including low volatility fixed income asset classes, which tend to have high Sharpe Ratios historically, can lead to better back tested results. However, this is unlikely to be a sound rule for investment; there may be reasons to question whether the high historical Sharpe Ratio for bonds can persist into the future. We believe that more research on methods for evaluating asset classes for inclusion into a Risk Parity portfolio would provide tremendous value to the industry.

TABLE 1
60/40 vs. Risk Parity Portfolio Heuristic for Stock and Bond

| | Excess | | |
|---|---|---|---|
| | Return over | | |
| | T-bill | Volatility | Sharpe Ratio |
| 60/40 S&P500/BarCap Agg | 5.1% | 10.1% | 0.50 |
| Risk Parity w/S&P500 and | 4.2% | 6.7% | 0.62 |
| BarCap Agg | | | |

Notes:
Time horizon is January 1980-June 2010.
The risk-free rate is the Three-Month Treasury Bill from St. Louis FED (http://research.stlouisfed.org/fred2/series/TB3MS).
S&P500 Total Returns are from Global Financial Data (http://www.globalfinancialdata.com).
BarCap Agg Total Returns are from Barclays Capital Live (http://live.barcap.com).

TABLE 2
Risk Parity vs. Other Portfolio Heuristics (with 9 Asset Classes)

| | Excess | | |
|---|---|---|---|
| | Return over | | Sharpe |
| | T-bill | Volatility | Ratio |
| 60/40 S&P500/BarCap Agg | 5.1% | 10.1% | 0.50 |
| U.S. Pension Model Portfolio (with | 5.1% | 9.8% | 0.52 |
| 60/40 anchor) | | | |
| Risk Parity Portfolio | 3.8% | 7.5% | 0.51 |
| Equal Weighting | 4.5% | 8.8% | 0.51 |
| Minimum Variance Weighting | 1.6% | 6.6% | 0.24 |
| Mean-Variance Optimal Weighting | 4.4% | 10.3% | 0.43 |

Notes:
Time horizon is January 1980-June 2010.
The risk-free rate is the Three-Month T-Bill from St. Louis FED (http://research.stlouisfed.org/fred2/series/TB3MS).
S&P500 Total Returns are from Global Financial Data (http://www.globalfinancialdata.com).
The BarCap Aggregate, US Long Term Treasury, US Corporate Investment Grade, and US Corporate High Yield Bond Total Returns are from BarCap Live (http://live.barcap.com). Global Bonds Total Returns through 1985 are from Global Financial Data, and since 1986 are from Bloomberg (JP Morgan Global Government Bond Index (JPMGGLBL)).
REITs Total Returns are from FTSI NAREIT Equity REITS series (http://www.REIT.com).
MSCI EAFE and MSCI EM Total Returns are from MSCI (http://www.mscibarra.com/products/indices/global_equity_indices/performance.html).
Commodities returns are the Dow Jones-AIG Commodity Index from Global Financial Data (http://www.globalfinancialdata.com).

TABLE 3
Sub-sample analysis of Sharpe Ratios: Risk Parity vs. Other Portfolio Heuristics
(with 9 Asset Classes)

| | Full Sample: | | | |
|---|---|---|---|---|
| | January 1980- | January 1980- | January 1990- | January 2000- |
| | June 2010 | December 1989 | December 1999 | December 2009 |
| 60/40 S&P500/BarCap Agg | 0.50 | 0.56 | 0.99 | 0.04 |
| U.S. Pension Model Portfolio (with | 0.52 | 0.63 | 0.89 | 0.15 |
| 60/40 anchor) | | | | |
| Risk Parity Portfolio | 0.51 | 0.39 | 0.69 | 0.54 |
| Equal Weighting | 0.51 | 0.49 | 0.64 | 0.48 |
| Minimum Variance Weighting | 0.24 | −0.02 | 0.28 | 0.49 |
| Mean-Variance Optimal Weighting | 0.43 | 0.60 | 0.56 | 0.18 |

Notes:
Time horizon is January 1980-June 2010.
The risk-free rate is the Three-Month T-Bill from St. Louis FED (http://research.stlouisfed.org/fred2/series/TB3MS).
S&P500 Total Returns are from Global Financial Data (http://www.globalfinancialdata.com).
The BarCap Aggregate, US Long Term Treasury, US Corporate Investment Grade, and US Corporate High Yield Bond Total Returns are from BarCap Live (http://live.barcap.com).
Global Bonds Total Returns through 1985 are from Global Financial Data, and since 1986 are from Bloomberg (JP Morgan Global Government Bond Index (JPMGGLBL)).
REITs Total Returns are from FTSI NAREIT Equity REITS series (http://www.REIT.com). MSCI EAFE and MSCI EM Total Returns are from MSCI (http://www.mscibarra.com/products/indices/global_equity_indices/performance.html).
Commodities returns are the Dow Jones-AIG Commodity Index from Global Financial Data (http://www.globalfinancialdata.com).

TABLE 4
Sensitivity of the Risk Parity Portfolio to Asset Class Inclusion

| | Excess | | Sharpe Ratio: | Sharpe Ratio: | Sharpe Ratio: | Sharpe Ratio: |
|---|---|---|---|---|---|---|
| | Return over | | January 1980- | January 1980- | January 1990- | January 2000- |
| | T-bill | Volatility | June 2010 | December 1989 | December 1999 | December 2009 |
| Risk Parity: | 3.3% | 7.5% | 0.45 | 0.26 | 0.58 | 0.55 |
| 5 Asset Classes | | | | | | |
| Risk Parity: | 3.8% | 7.5% | 0.51 | 0.39 | 0.69 | 0.54 |
| 9 Asset Classes | | | | | | |
| Equal Weighting: | 3.7% | 8.4% | 0.45 | 0.32 | 0.65 | 0.45 |
| 5 Asset Classes | | | | | | |
| Equal Weighting: | 4.5% | 8.8% | 0.51 | 0.49 | 0.64 | 0.48 |
| 9 Asset Classes | | | | | | |

Notes:
Time horizon is January 1980-June 2010. The risk-free rate is the Three-Month T-Bill from St. Louis FED (http://research.stlouisfed.org/fred2/series/TB3MS). S&P500 Total Returns are from Global Financial Data (http://www.globalfinancialdata.com). The BarCap Aggregate, US Long Term Treasury, US Corporate Investment Grade, and US Corporate High Yield Bond Total Returns are from BarCap Live (http://live.barcap.com). Global Bonds Total Returns through 1985 are from Global Financial Data, and since 1986 are from Bloomberg (J P Morgan Global Government Bond Index (JPMGGLBL)). REITs Total Returns are from FTSI NAREIT Equity REITS series (http://www.REIT.com). MSCI EAFE and MSCI EM Total Returns are from MSCI (http://www.mscibarra.com/products/indices/global_equity_indices/performance.html). Commodities returns are the Dow Jones-AIG Commodity Index from Global Financial Data (http://www.globalfinancialdata.com).

TABLE 5a
Sensitivity of the Risk Parity Portfolio to Asset Class Inclusion

| | Excess | | Sharpe Ratio: | Sharpe Ratio: | Sharpe Ratio: | Sharpe Ratio: |
|---|---|---|---|---|---|---|
| | Return over | | January 1980- | January 1980- | January 1990- | January 2000- |
| | T-bill | Volatility | June 2010 | December 1989 | December 1999 | December 2009 |
| Risk Parity Portfolio: | 3.7% | 6.8% | 0.54 | 0.40 | 0.71 | 0.62 |
| 9 Asset Classes + | | | | | | |
| BarCap Agg | | | | | | |
| Risk Parity Portfolio: | 3.8% | 7.5% | 0.51 | 0.39 | 0.69 | 0.54 |
| 9 Asset Classes | | | | | | |
| Equal Weighting: | 4.4% | 8.2% | 0.54 | 0.51 | 0.67 | 0.52 |
| 9 Asset Classes + | | | | | | |
| BarCap Agg | | | | | | |
| Equal Weighting: | 4.5% | 8.8% | 0.51 | 0.49 | 0.64 | 0.48 |
| 9 Asset Classes | | | | | | |

Notes:
Time horizon is January 1980-June 2010. The risk-free rate is the Three-Month T-Bill from St. Louis FED (http://research.stlouisfed.org/fred2/series/TB3MS). S&P500 Total Returns are from Global Financial Data (http://www.globalfinancialdata.com). The BarCap Aggregate, US Long Term Treasury, US Corporate Investment Grade, and US Corporate High Yield Bond Total Returns are from BarCap Live (http://live.barcap.com). Global Bonds Total Returns through 1985 are from Global Financial Data, and since 1986 are from Bloomberg (J P Morgan Global Government Bond Index (JPMGGLBL)). REITs Total Returns are from FTSI NAREIT Equity REITS series (http://www.REIT.com). MSCI EAFE and MSCI EM Total Returns are from MSCI (http://www.mscibarra.com/products/indices/global_equity_indices/performance.html). Commodities returns are the Dow Jones-AIG Commodity Index from Global Financial Data (http://www.globalfinancialdata.com).

TABLE 5b
Sensitivity of the Risk Parity Portfolio to Asset Class Inclusion

| | Excess | | Sharpe Ratio: | Sharpe Ratio: | Sharpe Ratio: | Sharpe Ratio: |
|---|---|---|---|---|---|---|
| | Return over | | January 1980- | January 1980- | January 1990- | January 2000- |
| | T-bill | Volatility | June 2010 | December 1989 | December 1999 | December 2009 |
| Risk Parity Portfolio: | 3.3% | 6.5% | 0.50 | 0.29 | 0.63 | 0.67 |
| 5 Asset Classes + | | | | | | |
| BarCap Agg | | | | | | |
| Risk Parity Portfolio: | 3.3% | 7.5% | 0.45 | 0.26 | 0.58 | 0.55 |
| 5 Asset Classes | | | | | | |
| Equal Weighting: | 3.7% | 7.5% | 0.49 | 0.36 | 0.68 | 0.51 |
| 5 Asset Classes + | | | | | | |
| BarCap Agg | | | | | | |
| Equal Weighting: | 3.7% | 8.4% | 0.45 | 0.32 | 0.65 | 0.45 |
| 5 Asset Classes | | | | | | |

Notes:
Time horizon is January 1980-June 2010. The risk-free rate is the Three-Month T-Bill from St. Louis FED http://research.stlouisfed.org/fred2/series/TB3MS). S&P500 Total Returns are from Global Financial Data (htp://www.globalfinancialdata.com). The BarCap Aggregate, US Long Term Treasury, US Corporate Investment Grade, and US Corporate High Yield Bond Total Returns are from BarCap Live (http://live.barcap.com). Global Bonds Total Returns through 1985 are from Global Financial Data, and since 1986 are from Bloomberg (J P Morgan Global Government Bond Index (JPMGGLBL)). REITs Total Returns are from FTSI NAREIT Equity REITS series (http://www.REIT.com). MSCI EAFE and MSCI EM Total Returns are from MSCI (http://www.mscibarra.com/products/indices/global_equity_indices/performance.html). Commodities returns are the Dow Jones-AIG Commodity Index from Global Financial Data (http://www.globalfinancialdata.com).

### Portfolio Weights

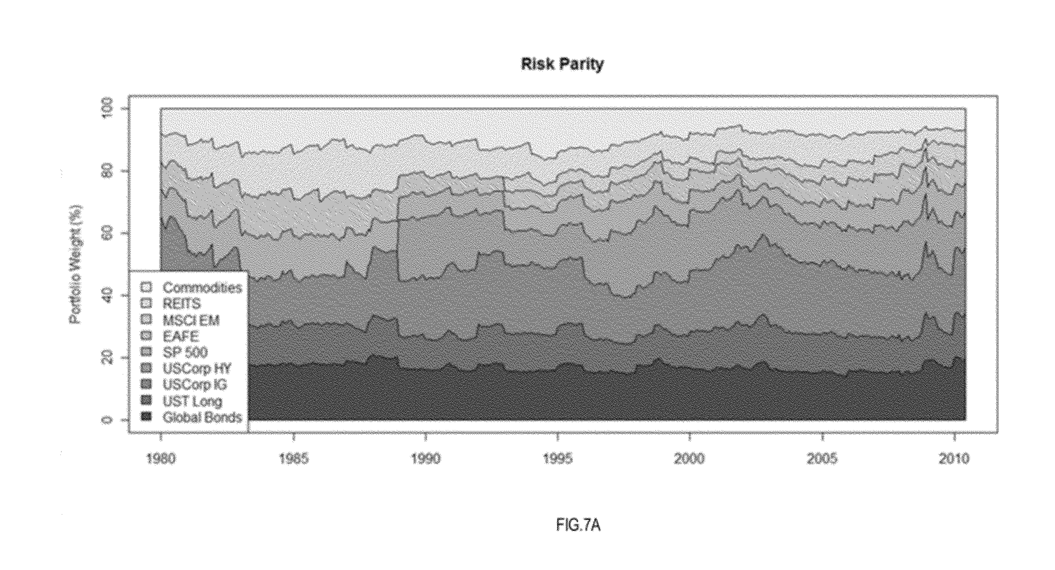

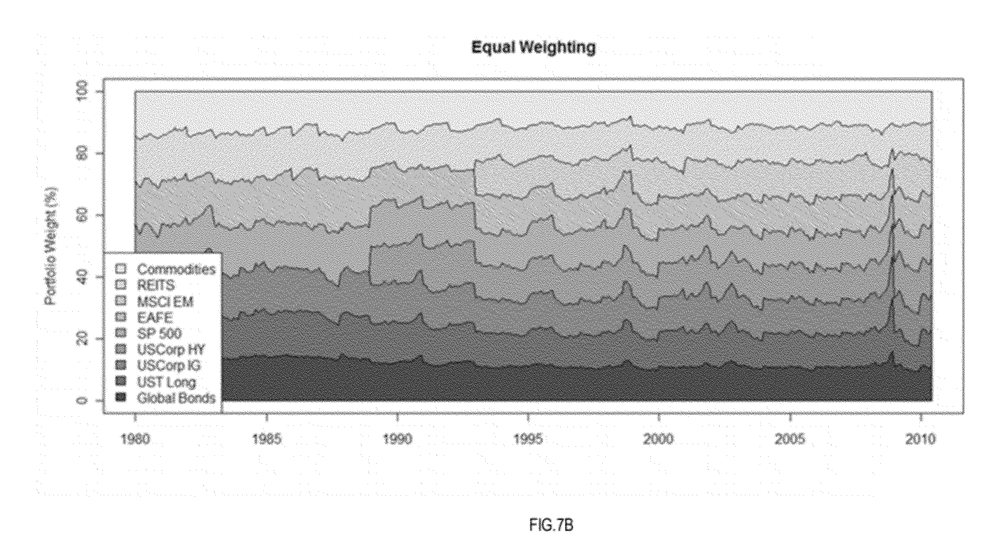

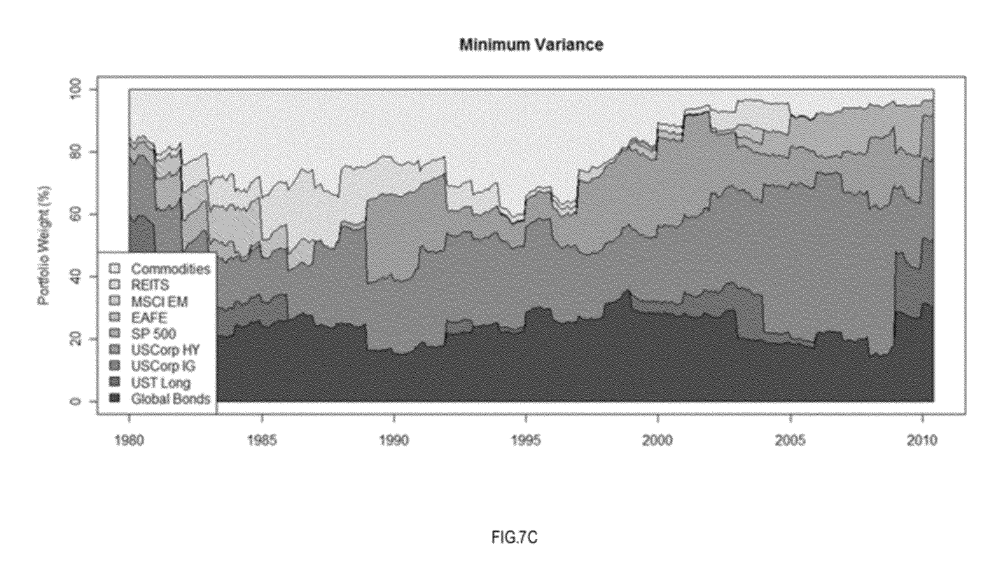

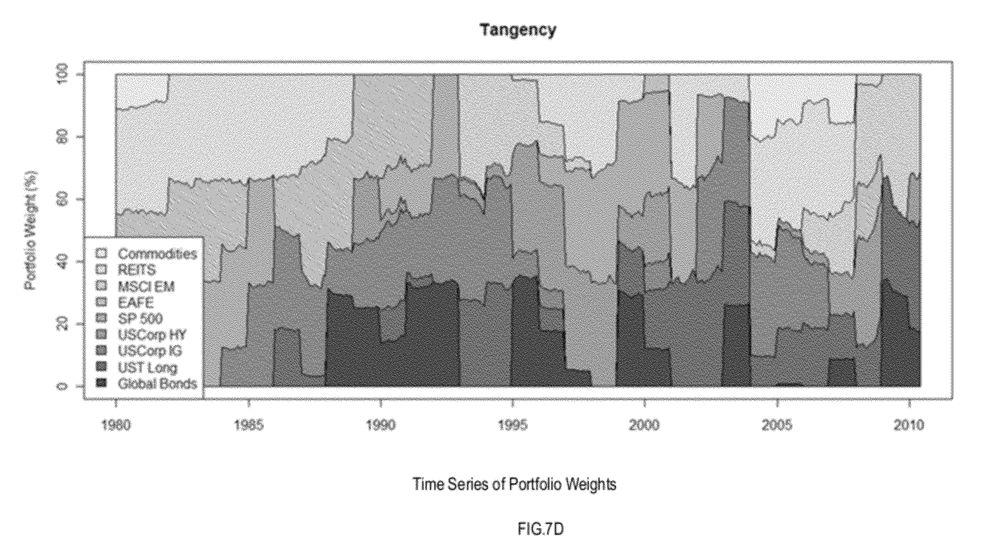

FIG. 7 compares the time-series of portfolio weights for the different strategies. Mean-variance optimization clearly has the highest turnover, followed by minimum variance. Risk Parity and equal weighting have similarly lower turnover. Not only do these two strategies have the best ex post performance, but the lower turnover also implies lower rebalancing costs.

### OVERVIEW OF VARIOUS EXEMPLARY EMBODIMENTS OF THE PRESENT INVENTION

An exemplary embodiment of the present invention set forth a flexible and robust and/or objective methodology for asset allocation based on risk factors as the investment universe. Portfolio optimization heuristics based on risk factors outperform their traditional asset-based counterparts in terms of both Sharpe and Information ratios in a dataset that spans over 30 years, according to an exemplary embodiment of the invention. The construction of risk factor(s), according to an exemplary embodiment of the invention, is based on standard Principal Component Analysis (PCA), but the approach is extended in at least two different directions. First, while PCA selects risk factors based solely on their variance, selection based on risk-adjusted past (or expected) performance provides superior results, according to an exemplary embodiment of the invention. Second, given that risk factors are usually not available as traded assets, the methodology, according to an exemplary embodiment of the invention, may effortlessly translate portfolio weights from a risk factor universe into asset weights. According to an exemplary embodiment of the invention, any restrictions imposed by managers or investors may be incorporated.

According to an exemplary embodiment, a computer data processing system of one or more processors may execute a statistical processing application that may perform a principal component analysis and an optimization application based on returns data and an asset class universe. An exemplary system may use a statistical computation engine such as, e.g., but not limited to, SAS available from SAS Institute of Cary, N.C. According one exemplary embodiment, a computationally intensive matrix algebra system may compute eigenvectors to computationally select principle factors for optimization.

Various other asset classes may be included in a portfolio, and asset allocation techniques may be used to allocate between asset classes. Conventional asset allocation techniques may include 60% in equities and 40% bonds allocation, for example. Another conventional approach may include equal weighting each asset class.

Conventional risk parity portfolios improve upon equal weighting all asset classes by performing equal volatility weighting, i.e., by weighting each asset class by multiplying by the inverse of volatility, or multiplying by 1 over the volatility. The risk parity portfolio is well known and generally has low volatility, however, it is comparable in risk performance (e.g., Sharpe Ratio) to equal weighting. However, conventional risk parity portfolio construction techniques do not properly take into account the correlation between asset classes. If one selects many asset classes that are correlated (such as, e.g., but not limited to, selecting many debt indexes or many equity indexes), or are subject to the same risk factor, then the risk parity portfolio (and equal weight portfolio) would not optimally allocate the portfolio. Thus, conventionally, success in risk parity portfolio selection depends on which asset classes are used in forming the portfolio.

According to an exemplary embodiment, a passive asset allocation portfolio is set forth. According to an exemplary embodiment, a passive asset allocation portfolio may be provided including equally weighting by risk the true underlying risk factor portfolios. According to an exemplary embodiment, one may extract orthogonal risk factors from a covariance matrix across asset classes and then may, e.g., but not limited to, equal volatility weight the principal component (PC) factors, according to an exemplary embodiment. According to an exemplary embodiment the method may decompose underlying risk that generates economic payout.

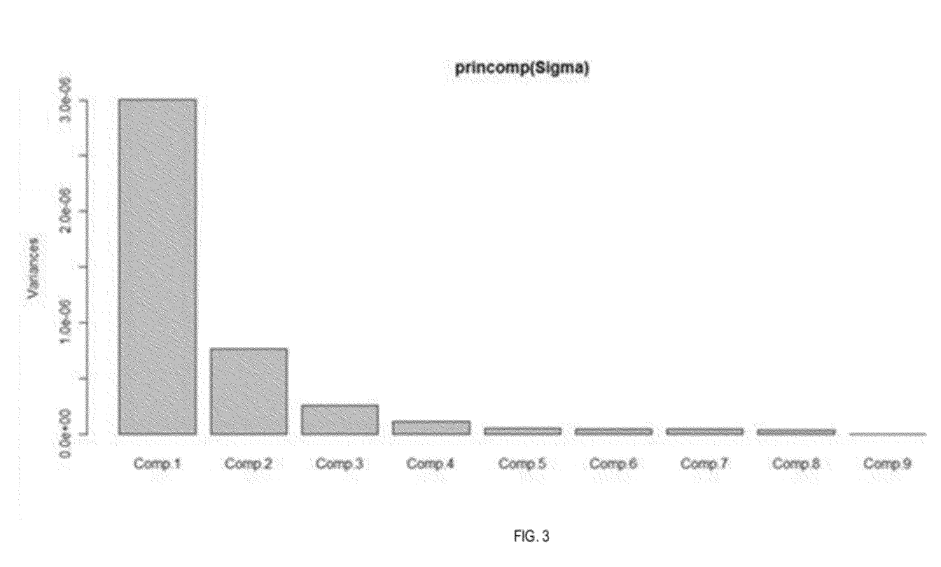

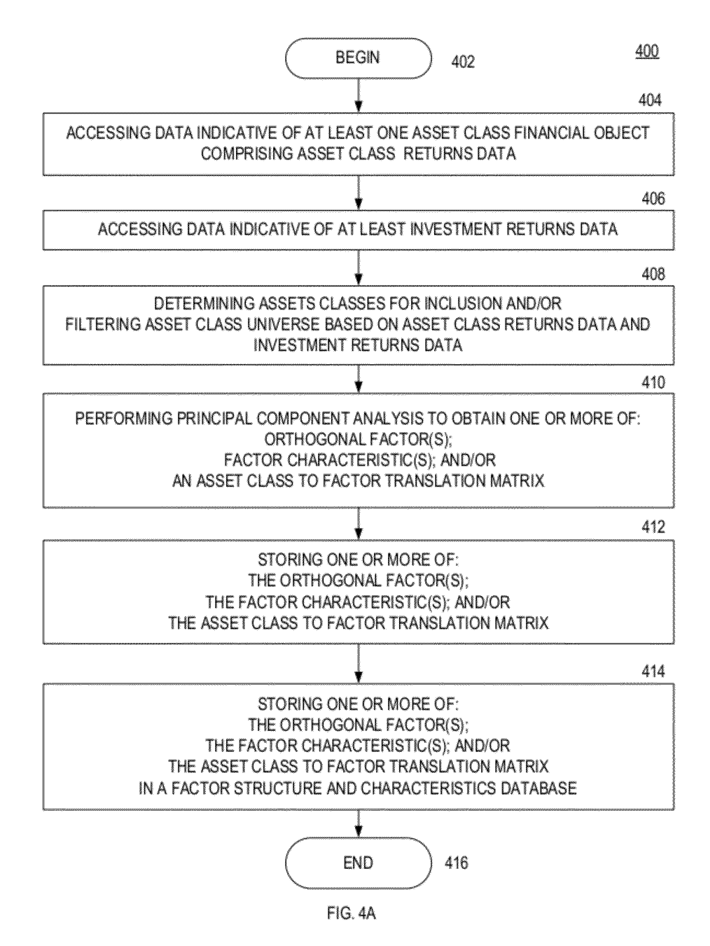

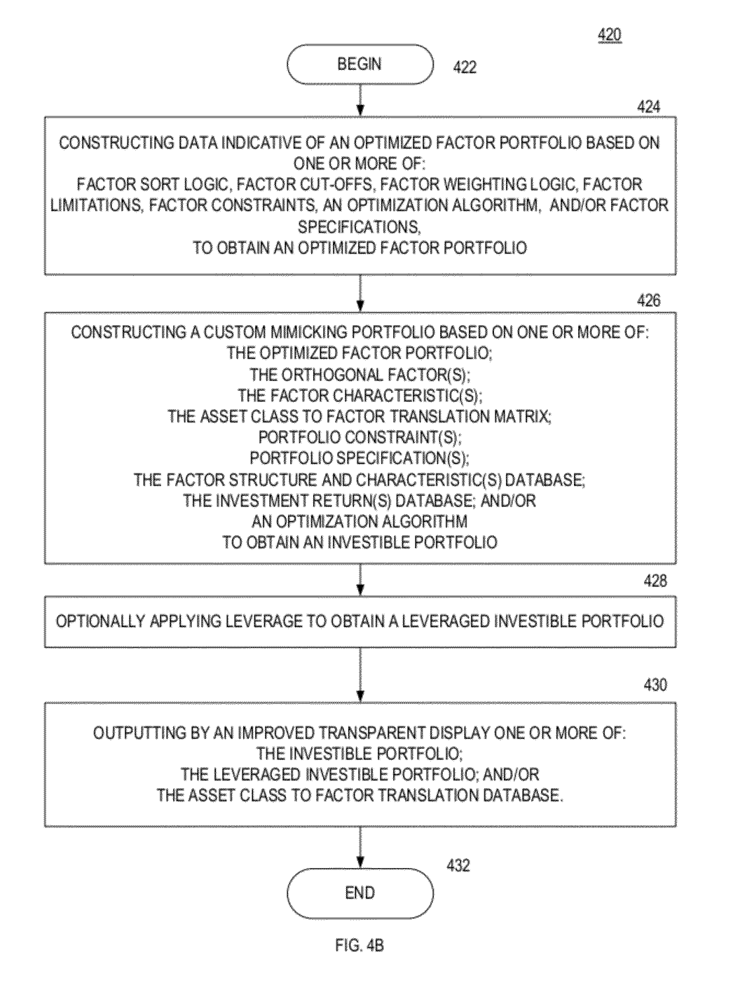

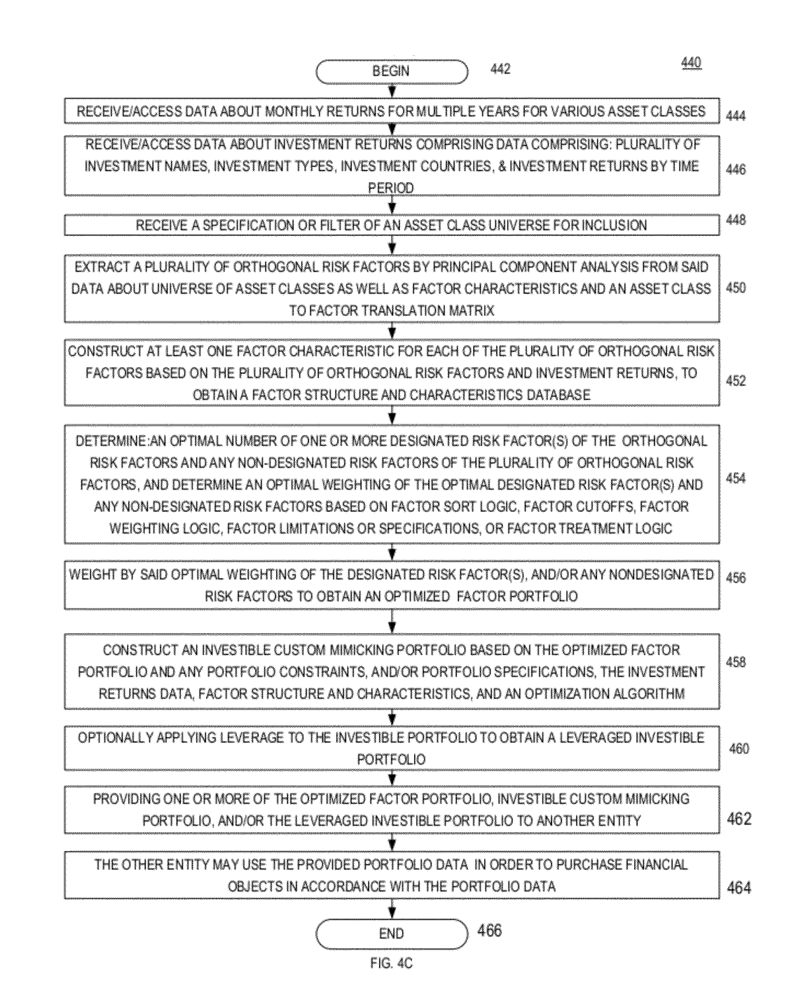

Table 6 depicts an initial result of the research below, where Risk Factor Parity # indicates the number of principal component factors used. Note from the graph of FIG. 3, it may be seen, that there may be only, e.g., but not limited to, 3 true principal components which may drive the nine (9) distinct asset classes that have been identified, according to an exemplary embodiment. The Risk Factor Parity.3 may outperform an exemplary naïve equal weighted (EQ) asset allocation portfolio, and the risk parity portfolio as indicated by the Sharpe Ratio measures. As can be seen in the exemplary graph, Risk Factor Parity.6 appears to insert useless noise into the process. The exemplary benchmark portfolio of 60/40 actually performs fairly well by comparison, indicating that equity and interest rate risks actually capture much of the risk factor premiums in the economy. The Markowitz tangency portfolio is based on recent 5 year performance. The exemplary graph depicts the eigenvector values of the covariance matrix, of the principal components. According to an exemplary embodiment, the optimization process according to an exemplary embodiment, may use principal component analysis (PCA) to extract factors and may determine an optimal grouping of factors, resulting in cutting the tail off of the graph in FIG. 3.

The orthogonal risk factors themselves are mathematically and/or statistically computed and may be named, according to an exemplary embodiment, for reference, such as, e.g., but not limited to, factor 1, factor 2, factor 3, etc., designated factor a, designated factor b, etc., non-designated factor a, nondesignated factor b, etc. The optimal factors for inclusion, as determined according to an exemplary embodiment, may be referred to as, e.g., but not limited to, a first grouping of factors, or a group of factors deemed designated factors. A second grouping of factors, according to an exemplary embodiment may be deemed a second grouping of factors, or a group of factors deemed nondesignated factors.

TABLE 6

| | | | | Max | Semi- |
|---|---|---|---|---|---|
| | Excess | Vola- | Sharpe | Draw- | Devia- |
| | Return | tility | Ratio | down | tion |
| Equal Weight (EQ) | 4.7% | 8.9% | 0.54 | 33.8% | 1.9% |
| US.60stock/40bonds | 5.8% | 10.9% | 0.53 | 26.5% | 2.3% |
| Global.60stock/40bonds | 5.0% | 10.3% | 0.49 | 32.0% | 2.2% |
| Risk.Parity - 9 asset | 3.8% | 7.5% | 0.51 | 25.3% | 1.6% |
| classes weighted by | | | | | |
| inverse | | | | | |
| Risk.Factor.Parity1 | 4.6% | 9.7% | 0.47 | 31.4% | 2.0% |
| Risk.Factor.Parity2 | 5.8% | 11.0% | 0.52 | 30.4% | 2.4% |
| Risk.Factor.Parity3 | 7.6% | 10.8% | 0.71 | 25.2% | 2.3% |
| Risk.Factor.Parity4 | 6.5% | 11.4% | 0.57 | 37.4% | 2.4% |
| Risk.Factor.Parity5 | 5.4% | 10.5% | 0.51 | 37.8% | 2.2% |
| Risk.Factor.Parity6 | 5.5% | 10.1% | 0.54 | 32.7% | 2.1% |
| 1953MarkowitzTangency | 1.4% | 11.5% | 0.12 | 39.4% | 2.2% |
| (not very attractive from | | | | | |
| risk return tradeoff) | | | | | |
| MinVar (restricted | 1.5% | 6.6% | 0.23 | 19.8% | 1.3% |
| version of Markowitz) | | | | | |

Exemplary Nine (9) Asset Classes

| | |
|---|---|
| UST_Long | (US Treasury Bonds) |
| USCorp_HY | (US High Yield Bonds) |
| USCorp_IG | (US Corporate Investment Grade Bonds) |
| SP_500 | (S&P 500) |
| Commodities | |
| REITS | |
| EAFE | (International Equity) |
| MSCI_EM | (Emerging Market Bonds) |
| Global_Bonds | (International Bonds) |

FIG. 7 sets forth an exemplary embodiment of charts illustrating exemplary time series of portfolio weights for exemplary risk parity, equal weighting, minimum variance, and tangency charts for an exemplary 30 year period graphing exemplary portfolio percentage weights for each of nine exemplary asset classes as described further above with reference to Table 6.

FIG. 1 illustrates an exemplary system 100 as may be used to implement an exemplary embodiment of the present invention. According to an exemplary embodiment, system 100 may include, e.g., but not limited to, an asset class returns database 102, a principal component analysis computational subsystem 108, an investment returns database 112, a factor structure and characteristics database 116, a factor optimization computer subsystem 118, a factor management subsystem 120, a portfolio specification subsystem 136, a portfolio construction subsystem 122, and custom portfolio construction subsystem 148. An asset class is a category of investment assets with similar return and risk characteristics. Examples of investment asset classes are cash, equities (stock), foreign equities, domestic equities, emerging equities, mutual funds, real estate investments, money markets, fixed income (bonds), investment grade bonds, high yield bonds, precious metals, currencies, commodities, etc.

According to an exemplary embodiment, the asset class returns database may be accessed and an asset specification or filter 104 may be used to obtain an asset class universe for inclusion 106. As shown, according to an exemplary embodiment, data indicative of an exemplary group of exemplary physical, tangible financial object asset classes may be specified for inclusion in a given universe for processing, or may be filtered to obtain the exemplary US Equities, Investment grade fixed instruments (FI), commodities, etc. For example, concrete, physical tangible financial objects, such as, e.g., but not limited to, currencies, real estate investments, fixed income assets, stocks, financial instruments, mutual funds, exchange traded funds, portfolios, etc. may be represented by data indicative of those tangible financial objects.

According to an exemplary embodiment, principal component analysis 110 processing may be performed on the asset class universe specified in 106, being executed on subsystem 108, and may produce a group of orthogonal factors 160, (represented in the illustration by beta1, beta2, beta3 . . . betaN), one or more factor characteristics 162, and an asset class to factor translation matrix 164. The output of the PCA 110 system as shown in 114 may be stored in, e.g., but not limited to, a factor structure and/or characteristics database 116, as shown, and may be accessible via computer system 118. The orthogonal factors arise from the mathematical and/or statistical processing in the principal component analysis process.

According to an exemplary embodiment, processor 118 may perform an optimization of the factor portfolio, taking as input from the factor management model 120, factor sort logic 126, factor cutoffs 130, factor weighting logic 132, optimization algorithm 134, and other factor treatment logic 128, etc., as well as, factor limitations and/or specifications from the portfolio specification system 136, according to an exemplary embodiment. The optimize factor portfolio process 140 may produce data indicative of, or output of data representative of an optimized factor portfolio 142. The optimization process may algorithmically determine an optimal first grouping of factors deemed designated factors, which are then used in the optimal portfolio, and may determine a second grouping being deemed nondesignated factors, the latter being minimized so as to determine an optimal factor portfolio.

The optimized factor portfolio 142 may be used to perform a process 152 of constructing a custom mimicking portfolio 152 taking into account portfolio constraints 144, and/or portfolio specifications 146 provided by portfolio specification subsystem 136, constructing the portfolio via computer subsystem 148 and an optimization algorithm 150 provided by portfolio construction subsystem 122, which may be used to convert/translate using the asset class-to-factor translation matrix into an investible portfolio 154.

According to an exemplary embodiment, the optimization process, may allow transformation into a custom mimicking portfolio by going back into the asset classes to factor translation matrix, to emulate exposure of the risk factors. According to an exemplary embodiment, the optimization process may take into account portfolio constraints and/or specifications in arriving at the investible custom mimicking portfolio.

According to an exemplary embodiment, the investible portfolio 154 may be provided to other entities as a tangible product, such as, e.g., but not limited to, an electronic disk or other storage medium capable of storing portfolio constituents and weightings, and such files may be either delivered by physical transfer of the storage medium, or by network transfer of an electronically stored, disassembled, and reassembled packet of data.

According to an exemplary embodiment, the investible portfolio 154 may be further processed, according to an exemplary embodiment to apply leverage processing 156 to the investible portfolio 154 as desired, optionally, to produce a leveraged investible portfolio 158, as shown.

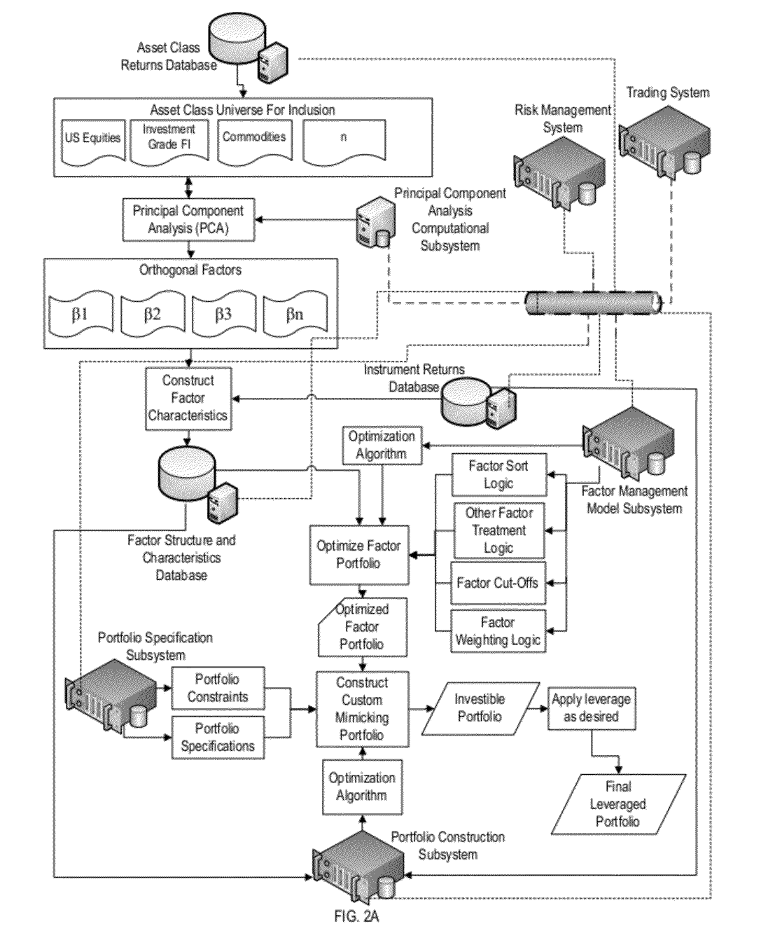

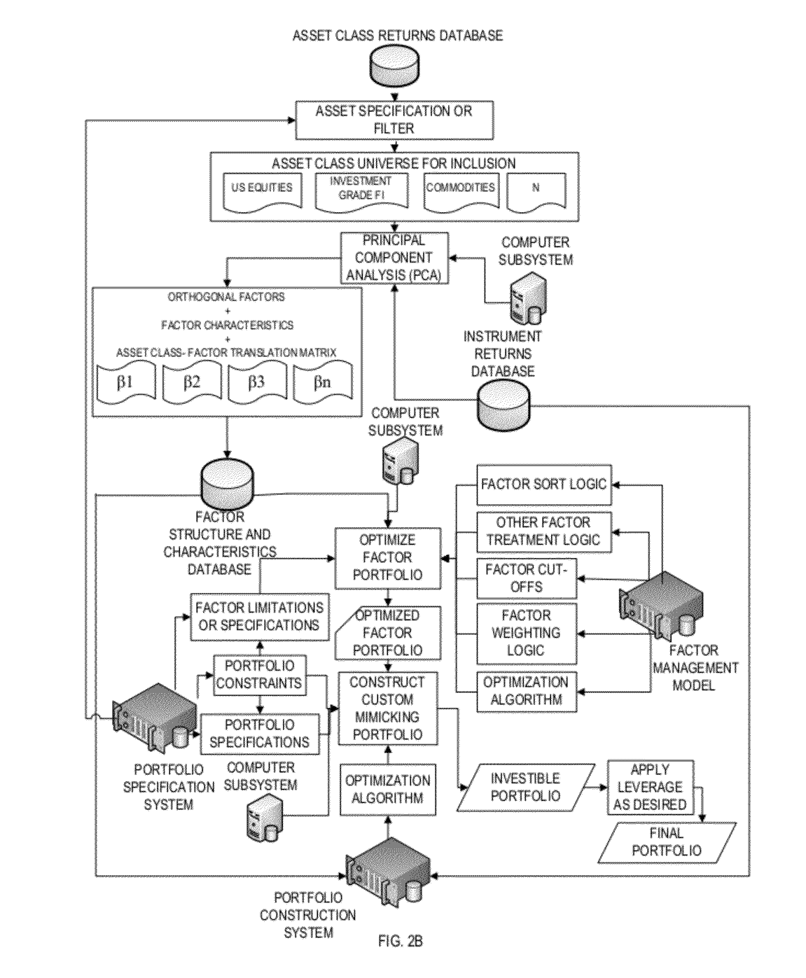

FIGS. 2A and 2B depict further exemplary embodiments reflecting exemplary computing environments as may be used in various exemplary, but non-limiting exemplary embodiments.

According to one exemplary embodiment, a factor extraction system 108 may be used to perform principal component analysis 110 to extract a universe of a plurality of orthogonal factors 160 for the n number of asset classes. The n asset classes selected may be obtained from an exemplary asset class returns database 102, which may, e.g., but not limited to, track, by asset class, a monthly return series for multiple years, in an exemplary embodiment. The factor extraction system may be used to describe the factors across all asset classes that determine the overall or joint portfolio (or collection of all asset classes in the universe). The set of orthogonal risk factors that drive the return of the universe of asset classes may thereby be determined. Orthogonal risk factors 160, according to an exemplary embodiment, may refer to data indicative of the unique betas within the regression that describes the relationship of the behavior of the algorithm.

According to an exemplary embodiment, an instrument returns database 112 may be used along with the orthogonal risk factors 160 of the overall portfolio (or rather collection of all asset classes in the universe) to construct factor characteristics for each of the risk factors 160. The instrument returns database 112 may include for each instrument, a name, a type of instrument, a country of the instrument, and quantitative returns data by time period, referred to collectively as the return structure. In an exemplary embodiment, for each factor, a simulation may run the factor against the historical instrument/asset returns data to determine descriptive things about each factor, such as, e.g., but not limited to, descriptiveness, volatility, standard deviation, return, etc. Ultimately factor characteristics 162 may be obtained, as well as an asset class-factor translation matrix 164 may be created, according to an exemplary embodiment, and may be stored in a factor structure and characteristics database 116, in an exemplary embodiment.

The PCA 110 and subsystem 108, in addition to creating the orthogonal factors 160, may create a factor-asset relationship, and/or translation matrix between each asset class and its underlying risk factors, and may in an exemplary embodiment, place, or store the data indicative of the matrix in the factor structure and characteristics database 116, according to an exemplary embodiment.

According to an exemplary embodiment, the orthogonal factors 160 and factor characteristics 162 data may be stored in the factor structure and characteristics database 116 for further access and/or processing.

According to an exemplary embodiment, the factor portfolio 140 may be optimized by running an optimization algorithm 134 against the factors 160 and factor characteristics 162 data. According to an exemplary embodiment, a factor management model and/or subsystem may provide various exemplary inputs to the risk factor portfolio optimization process. According to exemplary embodiment, various exemplary inputs from the factor management model may include, e.g., but not limited to, factor sort logic 126, factor cutoffs 130, factor weighting logic 132, and/or other factor treatment logic 128, the optimization algorithm 134, and/or factor limitations and/or specifications 138, as may be provided in an exemplary embodiment by a portfolio specification subsystem 136, etc.

According to exemplary embodiment, factor sorting logic 126 may be used to determine which characteristic by which to search, i.e., what characteristics are desired such as, e.g., but not limited to, return, variance, return*1/variance, a Sharpe ratio value, etc.

According to an exemplary embodiment, factor cutoffs 130 may include, e.g., but not limited to, which first grouping of factors, or designated factors are to be used such as, e.g., but not limited to, the top four (4) factors could be considered designated factors, and a second grouping of factors, the remaining factors, could be deemed nondesignated and could be minimized. In an exemplary embodiment, the optimizer 140 and processor 118 may use the designated factors, and may attempt to set the nondesignated factors initially to a zero value, for example, so as to disregard their influence. According to an exemplary embodiment, factor weighting logic may be provided to the optimizer 140, such as, e.g., but not limited to, equal weighting, weighting by 1 over the square root of the volatility, (i.e., by 1 over the variance), etc. Any or all factors from the factor management model 120 may be selected by a designer as inputs to an exemplary optimization process subsystem device, in an exemplary embodiment.

According to an exemplary embodiment, the optimizer 118 may optimize the risk factor portfolio 140 according to the factor management model 120 it may receive as input. The exemplary optimizer 118 may try to describe all behavior across all the asset classes based on the factor weights, and for example, based on the factor management model's cutoffs. For example, the model could for a cutoff use, e.g., but not limited to, 4, designated factors of an exemplary, but nonlimiting, 150 total factors. The factor management model subsystem 120, according to an exemplary embodiment, may sort by, e.g., but not limited to, volatility, and may, e.g., but not limited to, cut off at the exemplary top or designated 4 factors, and may optimize where each factor has its own weight, using the designated factors, and may tweak the factor weights according to the factor management model 120 to scale back some of the influence of a given nondesignated factor, if the factor seems to lessen the fit to the model 120, according to an exemplary embodiment. Further, the factor management model subsystem 120 according to an exemplary embodiment, may incorporate one or more, or a minimum nondesignated factor(s) (but preferably a minimal number of nondesignated factors). The factor management model subsystem 120, by performing this optimization algorithm 134 using, e.g., the sorting logic 126, cutoffs 130, and weighting logic 132, or alternative factor selection logic, may generate and obtain an optimized factor portfolio 142. The optimized factor portfolio 142 constructed by the optimization process 140 on optimizer 118 may include the plurality of risk factors and optimized weights for each of the orthogonal factors 160.

According to an exemplary embodiment, upon obtaining the optimized factor portfolio 142, an exemplary portfolio specification system 136 may be used to provide, e.g., but not limited to, exemplary portfolio constraints 144, and/or portfolio specifications 146, as may be used by a computer subsystem 148 and/or portfolio construction system 122 to construct a custom mimicking portfolio 152 which mimics the weights of the optimized factor portfolio 142 and may uses factor characteristics 162 (e.g., risk and return, and the asset class-factor translation matrix 164, in reverse) to mimic the optimized factor portfolio 142.

According to an exemplary embodiment, the custom mimicking portfolio 152 may be constructed using as input, e.g., but not limited to, portfolio constraints 144, and/or portfolio specifications 146, etc. from the exemplary portfolio specification system 136. Exemplary portfolio specifications 146 and constraints 144 may include, e.g., but not limited to, implementation specific constraints, customer, and/or product specific constraints such as, e.g., but not limited to, long only, or no emerging market sovereign debt, etc.

The translation matrix 164 of the risk factor relationships to asset classes may be used to reconstruct the investible portfolio based on the optimized risk factor portfolio and weights. An initial translation to obtain initial assets may be determined based on the translation matrix obtained from the PCA 110 and may be stored in the factor structure and characteristics database 116, and may be modified according to the portfolio specifications 146 and/or constraints 144 to obtain the mimicking portfolio. Depending on, e.g., the portfolio specifications 146, and/or constraints 144, the portfolio may be modified within such limits. For example, if a portfolio constraint 144 includes, e.g., but not limited to, long only, then alternative investible assets to the initial assets, may be chosen to similarly mimic the risk and return characteristics of the optimized factor portfolio 142, but which are investible based on meeting the portfolio requirements 144, 146 of the portfolio specification subsystem 136 optimally as optimized 150 by the portfolio construction system 122.

According to an exemplary embodiment, to construct the custom mimicking portfolio, the portfolio construction system 122 may receive as input the factor structure and characteristics database 116 data and the instrument returns database 112 and may use the optimization algorithm 150 to help construct the custom mimicking portfolio 152 taking into account the product specifications and constraints, outputting the investible portfolio 154. The portfolio construction system 122 may use the inputs to create an investible portfolio 154 based on the inventory of investible instruments from the instrument returns database 112 that mimics the optimized factor portfolio 142 outputted by process 140.

According to an exemplary embodiment, the custom mimicking portfolio 152 may be used to generate the investible portfolio 154 that may be designed to minimize tracking error with the optimized factor portfolio 142.

Using the investible portfolio 154, according to one exemplary embodiment, leverage may be applied to take the resulting investible portfolio 154, including, e.g., but not limited to, a low risk and low return portfolio to obtain a higher total return 158 through leverage 156, as desired. According to an exemplary embodiment, leverage may be used including, e.g., but not limited to, borrowing to obtain greater total return, for the cost of borrowing. By applying leverage to the investible portfolio, a final leveraged portfolio 158 may be obtained, according to an exemplary embodiment.

According to an exemplary embodiment, the investible portfolio 154 or 158 may be communicated (e.g., via a network) to, e.g., but not limited to, a risk management system, or a trading system. According to an exemplary embodiment, the investible portfolio 154, 158 may be provided as input to a portfolio manager to be used to trade investment assets according to the investible portfolio 154, 158. According to another exemplary embodiment, the portfolio manager may then purchase financial objects and/or assets in accordance with the investible portfolio 154, 158.

According to another exemplary embodiment, as the risk factors may change over time, a revised investible portfolio may be provided to the portfolio manager. According to another exemplary embodiment, e.g., but not limited to, from time to time, or periodically the portfolio manager may adjust the portfolio. According to another exemplary embodiment, e.g., but not limited to, from time to time, or periodically, the portfolio may be rebalanced according to the investible portfolio.

According to an exemplary embodiment, the system may be implemented via a number of subsystems and/or modules, which may be executed on one or more hardware processing devices. In one exemplary embodiment, the modules may be executed as subsystem modules on a SAS application system. In another exemplary embodiment, the subsystems may be implemented as subsystems and/or modules written in PEARL or C++, etc. The subsystems, according to an exemplary embodiment may access very large data files on the order of Terabytes of data comprising a half dozen decades of monthly series data which may be selected from a series or files, or a database, and may be flattened and processed to generate the optimized factor portfolio.

According to an exemplary embodiment, the subsystems of the present invention may be implemented on various networked hardware devices. In an exemplary embodiment, one or more of the asset class returns database, the instrument returns database, and/or the factor structure and characteristics database, may be implemented on one or more of the same databases. In an exemplary embodiment, one or more of the principal component analysis processor system, the factor management model subsystem, the portfolio specification subsystem, and/or or the portfolio construction subsystem may be implemented on one or more of the same networked, communicating computer processing systems. By implementing these subsystems on an integrated communicating network, the portfolios constructed may be delivered electronically, increasing the transfer speed, and transmission accuracy of the system.

One aspect to be provided is to generate a higher quality asset class to factor translation matrix while using less processor power and memory space, and to create transparency and predictability by moving to an automated process.

According to one exemplary embodiment, the electronic portfolio may be electronically communicated to other entities. In one exemplary embodiment, by electronically communicating the electronic portfolios to, e.g., but not limited to, external risk management subsystems and/or trading subsystems, data integrity is assured and electronic security of proprietary data may be efficiently transferred for further processing by the risk management subsystem or trading subsystem. The resulting system generates an optimized portfolio dataset comprising data indicative of a list of portfolio data constituents, from which trading and/or risk management decisions may be executed.

According to a an exemplary embodiment, another aspect of an exemplary embodiment may include improving a visual display of an output optimized factor portfolio or investible portfolio by using less processing power so as to improve the functioning of the computer.

### Risk Factor Portfolios

### Exemplary Process of Constructing the Factors

According to an exemplary embodiment, given a time-series of returns for an exemplary N assets, rₜ=[nₜ . . . r_{N,t}]′, one may start by constructing an exemplary associated covariance matrix

Ωₜ=cov(rₜ)=E[rₜ·rₜ′].

According to an exemplary embodiment, three (3) exemplary, but not limiting, different methods for calculating Ωₜ may be used, including, e.g., but not limited to, a) sample covariance, b) exponentially-weighted moving average (EWMA), and c) a shrinkage method based on Ledoit and Wolfe (2003), as will be apparent to those skilled in the relevant art.

According to an exemplary embodiment, one may also define

Σₜ=Mₜ⁻¹·Ωₜ·Mₜ⁻¹,

where Mₜ=\sqrt{diag(Ωₜ)} may give the correlation matrix Mₜ=Iₜ and the covariance matrix, in an exemplary embodiment.

According to an exemplary embodiment, one may find the risk factors, according to an exemplary embodiment, by using a principal component analysis (PCA) to find the N orthogonal factors Fₜ in Σₜ:

Σₜ=Vₜ·Dₜ·Vₜ′,

where Dₜ is a diagonal matrix where each element represents the variance of the respective factor, and Vₜ is an orthonormal matrix (Vₜ′·Vₜ=Vₜ·Vₜ′=Iₜ) that tells one both how to construct the factors

Fₜ=Vₜ′·Mₜ⁻¹·rₜ

as well as the loadings of each asset on the factors

rₜ=Mₜ·Vₜ·Fₜ.

### Exemplary Process of Ordering and Selecting the Factors

According to an exemplary embodiment, the factors may be sorted according to the variance explained, i.e., following Dₜ. According to an exemplary embodiment, one may also entertain, e.g., but not limited to, two (2) other exemplary possibilities, for a total of three (3) exemplary choices:

1. Variance explained—var(Fₜ)=diag(Dₜ)

2. Average or expected return—E[Fₜ]=Vₜ′·Mₜ⁻¹·E[rₜ]

3. Ratio of expected return to standard deviation—E[Fₜ]/\sqrt{var(Fₜ)}

According to an exemplary embodiment, a next step may involve, e.g., but not limited to, selecting the k factors one believes may be the most important ones. According to an exemplary embodiment, one may be agnostic about the best value for k and may try figures ranging from one (1) through six (6), according to one of the rules above, according to an exemplary embodiment.

### Exemplary Process of Weighting the Factors (Optimal Portfolio)

According to an exemplary embodiment, one may after selecting the k factors, set the optimal (desired) portfolio as a combination of the first k factors and may avoid the remaining N−k by assigning a weight of zero to the remaining factors:

gₜ*=[g_{1,t}* . . . g_{k,t}*0 . . . 0]′.

According to an exemplary embodiment, one may use one of, e.g., but not limited to, three (3) exemplary different approaches when weighting the factors:
1. Equal weighting or 1/n—all factors have the same weight.
2. Risk Parity—each factor weight is proportional to the inverse of its standard deviation 1/\sqrt{var(F_{g})}.
3. Mean-variance optimization—since the factors are orthogonal to each other, the weights are proportional to E[Fₜ]/var(Fₜ).

### Exemplary Process of Finding the Investible Portfolio

According to an exemplary embodiment, one ideally may like to invest in the optimal portfolio gₜ*′·Fₜ=gₜ*′·Vₜ′·Mₜ⁻¹·rₜ=wₜ*′·rₜ, however the weights wₜ′ in asset space might violate some restrictions imposed by a given type of product—such as, e.g., but not limited to, positivity, may usually be an important one. For example, a constraint or specification may be to avoid any short positions, or negative weightings, according to one exemplary embodiment. For this reason, in the last step one may optimize the actual, investible weights gₜ and wₜ according to an exemplary distance criterion subject to one or more product specifications and/or constraints:

min(gₜ−gₜ*)′·Zₜ·(gₜ−gₜ′) subject to product constraints.

Rearranging one may obtain an optimization in asset space.

min(wₜ−wₜ*)′·Mₜ·Vₜ·Zₜ·Vₜ′·Mₜ·(wₜ−wₜ) subject to product constraints.

According to an exemplary embodiment, there may be a few choices for the distance weighting matrix Zₜ. The identity matrix may give the Euclidian distance. Zₜ=1/\sqrt{Dₜ} may assign more weight to less volatile factors. Zₜ=\sqrt{Dₜ} may weight more heavily those factors with higher volatility. Empirical tests have indicated that the distance based on the inverse of the standard deviation (or the inverse of the variance) may provide performance improvement.

### Exemplary Process of Smoothing the Factor Construction and the Investable Weights

According to an exemplary embodiment, two exemplary sources of noise have been identified in factor construction methodology. The first source of noise one regards the fact that the principal component analysis is sign-invariant; both Fₜ and −Fₜ have the same variance and are therefore indistinguishable to the procedure. According to an exemplary embodiment, one may alleviate this issue, by filtering the factors by always choosing the version with a positive average return. According to an exemplary embodiment, one may eliminate uncertainty in many cases, but a few may still remain. (This may happen mostly when the factor's average return has a small magnitude and might switch its sign in a few months.)

According to an exemplary embodiment, a second source may relate to the sorting procedure. Two or more factors may have very similar values in the sorting criterion and therefore may switch positions in the factor ordering. When this causes the factors to get in or out of the factor investment universe, some noise may be created. According to one exemplary embodiment, one may implement a methodology unable to avoid these switches. According to another exemplary embodiment, one may implement a methodology to avoid these switches.

According to an exemplary embodiment, to reduce turnover caused by remaining noise that was not filtered out by the methods above, one may adopt, e.g., but not limited to, a six-month moving average of the weights.

### Risk Parity Overview

Risk Parity is a general term for a variety of investment techniques that attempt to take equal risk in different asset classes. Traditional portfolios are heavily exposed to stock market risk. For example, a standard institutional allocation of 60% stocks and 40% bonds has more than 90% of its risk from stocks, since stocks are so much more volatile than bonds. Typical Risk Parity portfolios allocate 25% of risk to each of stocks, government bonds, credit-related securities and inflation hedges (including real assets, commodities, real estate and inflation-protected bonds). This might result in 10% of dollar exposure to stocks, 40% to government bonds, 30% to credit-related securities and 20% to inflation hedges. The historical return of such a portfolio might be something like 50% of the historical return of the 60% stock/40% bond portfolio, with perhaps 25% of the risk. Risk Parity portfolios are often levered up to get the same expected return as a 60% stock/40% bond portfolio. In the example above, two times leverage would accomplish that, and produce a portfolio with the same expected return and half the risk of a standard portfolio (this is an example only, illustrating the type of result Risk Parity hopes to accomplish, not a prediction of actual investment results of any actual portfolio).

Risk Parity is intermediate between passive management and active management. Unlike market-weighted portfolios that automatically rebalance as prices change, Risk Parity portfolios must buy and sell to keep dollar holdings proportional to estimated future risk. If the price of a security goes up and risk levels remain the same, the Risk Parity portfolio will sell some of it to keep its dollar exposure constant. Or if the risk of an asset goes down, the Risk Parity portfolio will buy more to keep the amount of risk constant. On the other hand, Risk Parity does not require any forecasts of expected returns of various securities. It does not buy or sell securities on the basis of manager judgment of value.

Risk Parity portfolios differ considerably in practice. Different managers have different systems for categorizing assets into classes, different definitions of risk, different ways of allocating risk within asset classes, different forecasting methods for future risk and different ways of implementing the risk exposures. Moreover some investors use Risk Parity only as a neutral benchmark and take active bets relative to it based on forecasts or other techniques. Thus Risk Parity is a conceptual approach, like Indexing or Momentum investing, rather than a specific system.

### Principal Component Analysis (PCA) Overview

Principal component analysis (PCA) is a mathematical procedure that uses an orthogonal transformation to convert a set of observations of possibly correlated variables into a set of values of uncorrelated variables called principal components. The number of principal components is less than or equal to the number of original variables. This transformation is defined in such a way that the first principal component has as high a variance as possible (that is, accounts for as much of the variability in the data as possible), and each succeeding component in turn has the highest variance possible under the constraint that it be orthogonal to (uncorrelated with) the preceding components. Principal components are guaranteed to be independent only if the data set is jointly normally distributed. PCA is sensitive to the relative scaling of the original variables. Depending on the field of application, it is also named the discrete Karhunen-Lobve transform (KLT), the Hotelling transform or proper orthogonal decomposition (POD).

PCA was invented in 1901 by Karl Pearson. Now it is mostly used as a tool in exploratory data analysis and for making predictive models. PCA can be done by eigenvalue decomposition of a data covariance matrix or singular value decomposition of a data matrix, usually after mean centering the data for each attribute. The results of a PCA are usually discussed in terms of component scores (the transformed variable values corresponding to a particular case in the data) and loadings (the weight by which each standardized original variable should be multiplied to get the component score) (Shaw, 2003).

PCA is the simplest of the true eigenvector-based multivariate analyses. Often, its operation can be thought of as revealing the internal structure of the data in a way which best explains the variance in the data. If a multivariate dataset is visualized as a set of coordinates in a high-dimensional data space (1 axis per variable), PCA can supply the user with a lower-dimensional picture, a “shadow” of this object when viewed from its (in some sense) most informative viewpoint. This is done by using only the first few principal components so that the dimensionality of the transformed data is reduced.

PCA is closely related to factor analysis; indeed, some statistical packages (such as Stata) deliberately conflate the two techniques. True factor analysis makes different assumptions about the underlying structure and solves eigenvectors of a slightly different matrix.

### Exemplary Computer System Embodiments

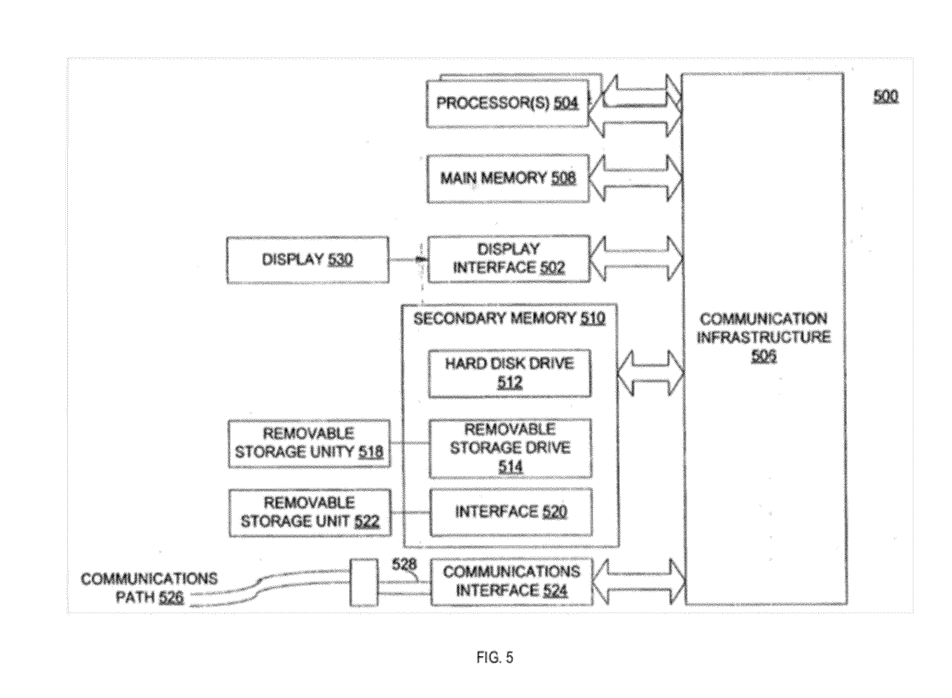

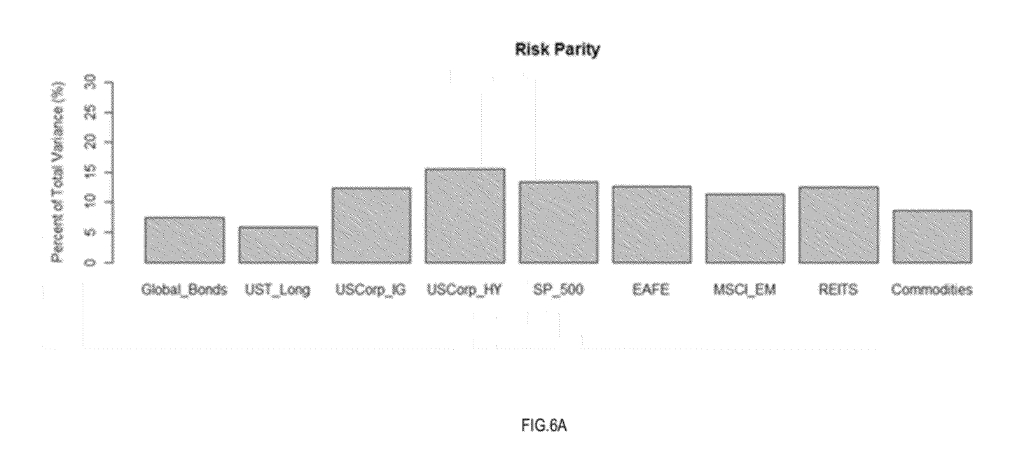

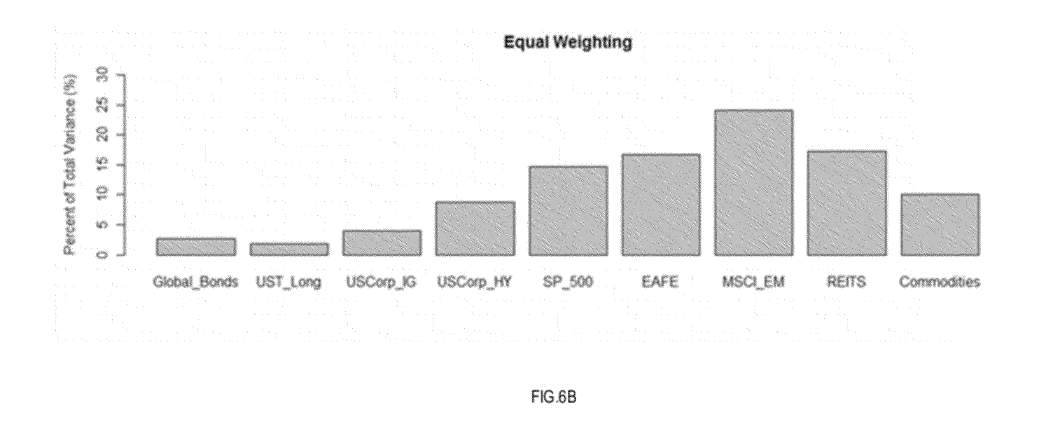

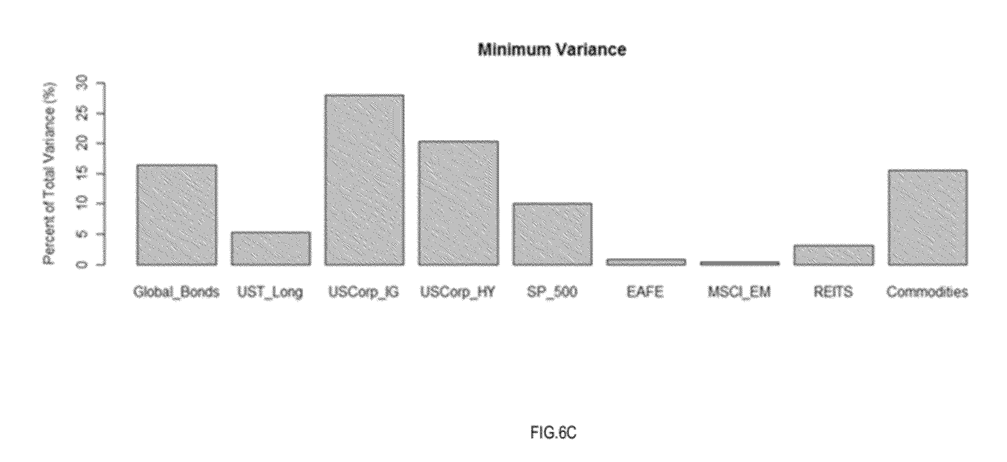

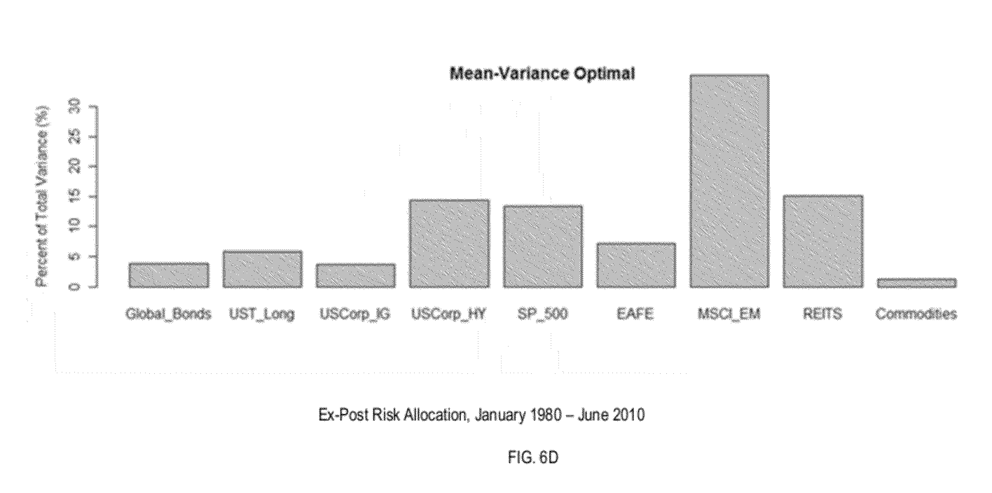

FIG. 5 depicts an exemplary computer system that may be used in implementing an exemplary embodiment of the present invention. Specifically, FIG. 5 depicts an exemplary embodiment of a computer system 500 that may be used in computing devices such as, e.g., but not limited to, a client and/or a server, etc., according to an exemplary embodiment of the present invention. FIG. 5 depicts an exemplary embodiment of a computer system that may be used as client device 500, or a server device 500, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 may be shown in FIG. 5, depicting an exemplary embodiment of a block diagram of an exemplary computer system useful for implementing the present invention. Specifically, FIG. 5 illustrates an example computer 500, which in an exemplary embodiment may be, e.g., (but not limited to) a personal computer (PC) system running an operating system such as, e.g., (but not limited to) MICROSOFT® WINDOWS® NT/98/2000/XP/CE/ME/VISTA/7/8, etc. available from MICROSOFT® Corporation of Redmond, Wash., U.S.A., MacOS, iOS, or MacOS/X, etc., available from Apple Corporation of CA, U.S.A. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 may be shown in FIG. 5. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, mobile phones, smartphones, communication devices, Iphone, Ipad, Tablet, thin clients, thick clients, proxy servers, network communication servers, remote access devices, client computers, server computers, routers, web servers, data, media, audio, video, telephony or streaming technology servers, etc., may also be implemented using a computer such as that shown in FIG. 5. Services may be provided on demand using, e.g., but not limited to, an interactive television (iTV), a video on demand system (VOD), and via a digital video recorder (DVR), or other on demand viewing system.

The computer system 500 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As may be appreciated, the removable storage unit 518 may include a nontransitory computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and/or a memory chip, SDRAM, USB card device, etc.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 500.

Computer 500 may also include an input device 516 such as, e.g., (but not limited to) a mouse or other pointing device such as a digitizer, and a keyboard or other data entry device (not shown).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

In one or more embodiments, the present embodiments are embodied in machine-executable instructions. The instructions can be used to cause a processing device, for example a general-purpose or special-purpose processor, which is programmed with the instructions, to perform the steps of the present invention. Alternatively, the steps of the present invention can be performed by specific hardware components that contain hardwired logic for performing the steps, or by any combination of programmed computer components and custom hardware components. For example, the present invention can be provided as a computer program product, as outlined above. In this environment, the embodiments can include a machine-readable medium having instructions stored on it. The instructions can be used to program any processor or processors (or other electronic devices) to perform a process or method according to the present exemplary embodiments. In addition, the present invention can also be downloaded and stored on a computer program product. Here, the program can be transferred from a remote computer (e.g., a server) to a requesting computer (e.g., a client) by way of data signals embodied in a carrier wave or other propagation medium via a communication link (e.g., a modem or network connection) and ultimately such signals may be stored on the computer systems for subsequent execution).

### Exemplary Communications Embodiments

In one or more embodiments, the present embodiments are practiced in the environment of a computer network or networks. The network can include a private network, or a public network (for example the Internet, as described below), or a combination of both. The network includes hardware, software, or a combination of both.

From a telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them called interprocess communication pathways.

On these pathways, appropriate communications protocols are used. The distinction between hardware and software may not be easily defined, with the same or similar functions capable of being preformed with use of either, or alternatives.

An exemplary computer and/or telecommunications network environment in accordance with the present embodiments may include node, which include may hardware, software, or a combination of hardware and software. The nodes may be interconnected via a communications network. Each node may include one or more processes, executable by processors incorporated into the nodes. A single process may be run by multiple processors, or multiple processes may be run by a single processor, for example. Additionally, each of the nodes may provide an interface point between network and the outside world, and may incorporate a collection of sub-networks.

As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently.

In an exemplary embodiment, the processes may communicate with one another through interprocess communication pathways (not labeled) supporting communication through any communications protocol. The pathways may function in sequence or in parallel, continuously or intermittently. The pathways can use any of the communications standards, protocols or technologies, described herein with respect to a communications network, in addition to standard parallel instruction sets used by many computers.

The nodes may include any entities capable of performing processing functions. Examples of such nodes that can be used with the embodiments include computers (such as personal computers, workstations, servers, or mainframes), handheld wireless devices and wireline devices (such as personal digital assistants (PDAs), modem cell phones with processing capability, wireless e-mail devices including BlackBerry™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Communications between the nodes may be made possible by a communications network. A node may be connected either continuously or intermittently with communications network. As an example, in the context of the present invention, a communications network can be a digital communications infrastructure providing adequate bandwidth and information security.

The communications network can include wireline communications capability, wireless communications capability, or a combination of both, at any frequencies, using any type of standard, protocol or technology. In addition, in the present embodiments, the communications network can be a private network (for example, a VPN) or a public network (for example, the Internet).

A non-inclusive list of exemplary wireless protocols and technologies used by a communications network may include BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). Also included are various generation wireless technologies. An exemplary non-inclusive list of primarily wireline protocols and technologies used by a communications network includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

The embodiments may be employed across different generations of wireless devices. This includes 1G-5G according to present paradigms. 1G refers to the first generation wide area wireless (WWAN) communications systems, dated in the 1970s and 1980s. These devices are analog, designed for voice transfer and circuit-switched, and include AMPS, NMT and TACS. 2G refers to second generation communications, dated in the 1990s, characterized as digital, capable of voice and data transfer, and include HSCSD, GSM, CDMA IS-95-A and D-AMPS (TDMA/IS-136). 2.5G refers to the generation of communications between 2G and 3 G. 3G refers to third generation communications systems recently coming into existence, characterized, for example, by data rates of 144 Kbps to over 2 Mbps (high speed), being packet-switched, and permitting multimedia content, including GPRS, 1xRTT, EDGE, HDR, W-CDMA. 4G refers to fourth generation and provides an end-to-end IP solution where voice, data and streamed multimedia can be served to users on an “anytime, anywhere” basis at higher data rates than previous generations, and will likely include a fully IP-based and integration of systems and network of networks achieved after convergence of wired and wireless networks, including computer, consumer electronics and communications, for providing 100 Mbit/s and 1 Gbit/s communications, with end-to-end quality of service and high security, including providing services anytime, anywhere, at affordable cost and one billing. 5G refers to fifth generation and provides a complete version to enable the true World Wide Wireless Web (WWWW), i.e., either Semantic Web or Web 3.0, for example. Advanced technologies may include intelligent antenna, radio frequency agileness and flexible modulation are required to optimize ad-hoc wireless networks.

As noted, each node 102-108 includes one or more processes 112, 114, executable by processors 110 incorporated into the nodes. In a number of embodiments, the set of processes 112, 114, separately or individually, can represent entities in the real world, defined by the purpose for which the invention is used.

Furthermore, the processes and processors need not be located at the same physical locations. In other words, each processor can be executed at one or more geographically distant processor, over for example, a LAN or WAN connection. A great range of possibilities for practicing the embodiments may be employed, using different networking hardware and software configurations from the ones above mentioned.

### I. MOTIVATION

Portfolio allocation based on risk is not a new concept. In fact, the classic portfolio optimization problem in Markowitz (1952) can be restated as finding the optimal weights of the tangency portfolio, r_{T}=Σᵢ₌₁^{N}wᵢ·rᵢ, such that

$$\frac{E [ {r}_{i} ] - {r}_{f}}{cov ( {r}_{i} , {r}_{T} )} = \frac{E [ {r}_{j} ] - {r}_{f}}{cov ( {r}_{j} , {r}_{T} )} \qquad ( 1 )$$

for all pairs (i,j). In other words, the optimal (highest Sharpe ratio) portfolio in Markowitz's efficient frontier equalizes the risk-adjusted excess return of all assets in the economy, where risk is measured as covariance with a single factor: the tangency portfolio. If this was not the case, smart investors would buy the cheap assets, sell the dear ones and reap the rewards. This result, combined with a market equilibrium or clearing argument, is the foundation of the Sharpe (1964)-Lintner (1965) CAPM and of modern finance.

Why then are managers and investors always looking for new allocation strategies?

The first reason is based on an extensive literature (Jobson and Korkie (1981) and Michaud (1989), among others) arguing that the parameters necessary to implement this strategy are imprecise at best and misguiding at worst, since past data is no reliable indication of future or expected values. Consider, for instance, the following two widely used allocation strategies: equal weighting and minimum variance. While mean-variance optimization assumes that expected returns (means) and covariances are known a priori, equal weighting comprising portfolio weights, that are in an exemplary embodiment, of exemplary identical weight across all assets and exemplifies the distrust in the parameters. If one doesn't have reliable means and covariances, why bother using them at all? Minimum variance is a balance between full knowledge and complete lack of information. It is usually justified by the widespread view that second moments are more precisely estimated than first moments (Merton (1980)). If risk (covariance) only is known, the optimal approach is to disregard expected returns and minimize total portfolio variance. See DeMiguel, Garlappi and Uppal (2009) and Chow, Hsu, Kalesnik and Little (2010) for a comparison between these and other portfolio strategies applied to U.S. and global equity portfolios and Chaves, Hsu, Li and Shakernia (2011) for comparisons using a universe of asset classes. We agree that parameter estimation is an important and complicated part of any implementation, but our focus here is on a different point.

The second reason for new strategies is the view that market risk—even if one knew how to measure it (Roll (1977)'s critique of the CAPM and related asset pricing models is based on the fact that every individual asset—including non-traded, illiquid and even non-measurable ones—should be included in a measure of the market portfolio, rendering any attempts to test these models infeasible)—would likely not be the only source of risk in an economy. This is the motivation for successful asset pricing models such as the ICAPM (Merton (1973)) and the APT (Ross (1976)). However, in most applications multi-factor models provide only an adjustment for the expected returns and covariances of the assets. Traditional portfolio optimization—or one of the other heuristics above—is still required. We argue, instead, that a methodology that allocates funds based on the risk factors themselves would be a superior alternative.

To the best of our knowledge, the first broadly available strategy that tackles this problem is known as risk parity. In its simplest form, the weights on the assets are assigned in inverse proportion to their standard deviations, in an attempt to balance their risk contributions, measured as contribution to total portfolio variance. See Maillard, Roncalli and Teïletche (2010) for a detailed presentation of risk parity strategies. But risk parity also has its critics. See Maillard, Roncalli and Teïletche (2010) for a detailed presentation of risk parity strategies. In a previous paper—Chaves, Hsu, Li and Shakernia (2011)—we make the point that this strategy provides good diversification in terms of risk contribution, but its performance is too sensitive to the investment universe and, in particular, to highly correlated assets. Bhansali (2011) reinforces the argument, noting that: “Although risk parity as traditionally implemented attempts to equalize risk across assets, we think that a more robust approach is to allocate instead to ‘risk factors’ embedded inside the assets.”

This paper takes a step towards this goal and develops a methodology to implement asset allocation based on risk factors. An exemplary embodiment of our methodology may comprise four intuitive steps. The first one may calculate the risk factors using a common statistical procedure called Principal Component Analysis, or PCA. PCA is widely used in fixed income research and practice, where the “level”, “slope” and “curvature” factors are almost universal. See Litterman and Scheinkman (1991) for a formal exposition. This procedure finds the characteristics of the risk factors and establishes their relation with the underlying assets. In the second exemplary element we identify and select only those exemplary factors that provide the most attractive risk-adjusted returns. The third exemplary element is responsible for the portfolio allocation and is flexible enough to accept most strategies commonly used in asset allocation. Finally, the in the fourth exemplary element, which may be crucial, since it may allow us to translate the risk factor allocations from the third stage into investable asset portfolios while, at the same time, taking into consideration any restrictions imposed by managers, investors or type of product.

The next section describes the technical aspects of our methodology. It contains all the details necessary to implement the strategies analyzed in the paper, but it is also comprehensive enough as to allow variations or extensions.

In the results section, we provide comparisons between two versions of the four well known portfolio strategies discussed before: equal-weighting, risk parity, mean-variance optimization and minimum variance portfolio. The first version of each strategy is considered as our benchmark and is implemented in a universe of diverse asset classes, as is usually done in practice. The second version uses the same sample and universe, but allocates according to risk factors and follows the methodology derived in this paper. We do not favor one strategy over another. Instead, we show that the risk factor version of the strategies consistently outperforms the asset-based version, its benchmark, both in absolute terms—Sharpe ratio—as well as in relative terms-Information ratio.

### A. EXAMPLE

A simple yet concrete example might help clarify our argument in favor of risk factors. Consider a traditional pension strategy that allocates its funds according to a 60/40 equity-to-bond ratio using the S&P 500 Index and the Barclays Capital U.S. Aggregate Bond (Bar Cap Agg) Index. To understand the risk (volatility) contribution from each of these two assets, we start with a simple risk attribution analysis. Table 7 reports that stocks are responsible for 90 percent of this portfolio's volatility, whereas bonds are the source of the remaining 10 percent. The risk contribution of each asset i (weight cᵢ and return rᵢ) in a portfolio with N assets is calculated by:

$$\frac{{\sum }_{j = 1}^{N} {c}_{i} \cdot {c}_{j} \cdot cov ( {r}_{i} , {r}_{j} )}{{\sum }_{i = 1}^{N} {\sum }_{j = 1}^{N} {c}_{i} \cdot {c}_{j} \cdot cov ( {r}_{i} , {r}_{j} )} .$$

As impressive as these numbers might be, we claim that they still do not reveal the total extent of the risk (mis)allocation. Given that the correlation between the monthly returns of the two indexes is 21 percent, the Bar Cap Agg index has a component that follows the S&P 500 and therefore is exposed to equity risk as well. The question then is how to account for this extra exposure?

For ease of exposition, we adopt a simplified strategy to separate those two types of risk. We run the following regression:

rₜ^{Bar Cap Agg}=α+β·rₜ^{S&P 500}+εₜ (2)

and call εₜ the ‘pure’ bond risk factor. Notice that εₜ is orthogonal to rₜ^{S&P 500} by construction and, more importantly, that a fraction of the amount invested in the Bar Cap Agg index ends up indirectly allocated to the S&P 500. This extra exposure to the equity risk factor depends on the magnitude of β. Updating the calculations for our 60/40 example using the new orthogonal risk factors, rₜ^{S&P 500} and εₜ, we obtain even more extreme risk contributions of 95 percent for equities and only 5 percent for bonds.

The disparity between dollar allocations and risk allocations is a common problem raised by proponents of risk parity strategies. For this reason, our next portfolio follows exactly their proposed solution, i.e., we choose weights that are inversely proportional to the standard deviation of each asset. The next group of rows in Table 7 shows that this strategy results in an allocation of 27 and 73 percent to equities and bonds, and that the risk contribution from the assets, as desired, are equally split. However, the factor risk contributions still favor the equity factor with 61 percent, versus only 39 percent for the bond factor.

The last three rows in Table 7 show that in order to achieve an equally balanced distribution according to risk factors, one has to allocate 22 and 78 percent, respectively, to the S&P 500 and Bar Cap Agg indexes. The portfolios above exemplify that neither dollar nor asset volatility diversification are the same as risk factor diversification, even with a relatively low correlation and only two assets.

As one last observation, we purposely did not address the very important topic of portfolio performance in the discussion above. The reasons for this are twofold. First, we believe that claiming superior performance using only two assets is a meaningless exercise. We postpone any analysis of results for a later section, after we present our full-fledged methodology and where we use a more diverse asset universe. Second, some papers (e.g., Inker (2011)) have correctly argued that bonds have performed relatively better in the last few decades following a decrease in inflation and interest rates. Therefore, any strategy with a tilt towards fixed income, as is the case with the portfolios above, would almost certainly look more attractive.

### II. Methodology

This section contains the main part of the paper. It describes the construction of the risk factors and how to form optimal portfolios using them. Obviously, the number of risk factors one might consider is significantly smaller than the number of assets available. For this reason, the next step after constructing the factors is to select the best ones. We provide a few options in this section and present their empirical results later in the paper. Another important point to keep in mind is that the risk factors obtained here are not directly traded. For this reason we also present a technique that allows us to replicate the risk factor-based portfolio using the tradable assets as well as to include common investing constraints, such as non-negativity.

### A. Risk Factor Construction

Given a time-series of returns for N asset classes, rₜ=[r_{1,t} . . . r_{N,t}]′, we start by constructing the associated covariance matrix Ωₜ=cov(rₜ)=E[(rₜ− r̅ₜ)·(rₜ− r̅ₜ)′]. The methodology is transparent regarding the numerical approach used to calculate Ωₜ·1 We also define: 1 Some of the possible approaches include, but are not limited to: sample covariance, exponentially-weighted moving average (EWMA) and a shrinkage method based on Ledoit and Wolf (2003).

Σₜ=Mₜ⁻¹·Ωₜ·Mₜ⁻¹, (3)

where Mₜ=diag(t) gives us the correlation matrix and Mₜ=Iₜ the covariance matrix.

To find the risk factors Fₜ, we use Principal Component Analysis, or PCA. This statistical technique takes a covariance (correlation) matrix Σₜ as input, and produces the following decomposition:

Σₜ=Vₜ·Dₜ·Vₜ′. (4)

Dₜ is a diagonal matrix that represents the covariance matrix of the N factors,

Dₜ=cov(Fₜ)=E[(Fₜ− F̅ₜ)·(Fₜ− F̅ₜ)′]. (5)

Vₜ is an orthonormal matrix,

Vₜ′·Vₜ=Vₜ−Vₜ·Vₜ′=Iₜ, (6)

that tells us both how to construct the factors,

Fₜ=Vₜ′·Mₜ⁻¹·rₜ, (7)

as well as the loadings of each asset on the factors, (To see that this is indeed the case just calculate:

cov(rₜ)=cov(Mₜ·Vₜ·Fₜ)=Mₜ·Vₜ·cov(Fₜ)·Vₜ′·Mₜ=Mₜ·Vₜ·Dₜ·Vₜ′·Mₜ=Mₜ·Σₜ·Mₜ=Ωₜ.)

rₜ=Mₜ·Vₜ·Fₜ. (8)

PCA has three characteristics that make it attractive. First, since Dₜ is a diagonal matrix, the factors are orthogonal or uncorrelated. Second, as illustrated by Equations (7) and (8), switching from the asset domain to the factor domain requires only the transposing of Vₜ. Third, the elements in Dₜ are usually sorted in decreasing order, i.e., the first factor explains as high an amount of total assets' variation as possible; the second factor the second highest and so on. Alternatively, PCA can be viewed as a sequence of optimization problems of the form:

max_{{c}_{ᵢ}_{}}var(cᵢ′·rₜ)s.t.cᵢ′·cᵢ=1 and cᵢ′·cⱼ=0∀j<i.

Forming portfolios using all N factors as the investment universe would not be an optimal approach. First, one would expect the number of risk factors to be much smaller than the number of assets, especially for large N. Second, many risk factors might not represent attractive investment opportunities or might carry no risk premium at all. Industry factors in equity markets are a common example of factors that are usually considered to provide no risk-adjusted returns (e.g., Fama and French (1997)). Given these observations, we deal first with the choice of which risk factors to consider, and then with the subsequent portfolio construction stage.

### B. Risk Factor Selection

Originally the factors are sorted according to their variance, i.e., following Dₜ. Since this choice only takes into account the risk (variance) of each factor, we entertain two other possibilities that might provide more accurate estimates of the risk-adjusted risk premiums of the factors:
4. Sharpe ratio—E[F_{i,t}]/\sqrt{var(F_{i,t})}.
5. Risk premium from cross-sectional regression—This approach estimates the risk premium λᵢ for each factor using cross-sectional regressions of E[rₜ] on the assets loadings (columns of Vₜ), and then uses the statistical significance λᵢ/s.e. (λᵢ) to sort them.

These two approaches find strong theoretical support in Merton (1973)'s ICAPM and Ross (1976)'s APT.

The next step involves selecting the k factors we believe are the most important ones. At this moment we are agnostic about the best value for k. In the results section below we try values ranging from one through four, according to one of the two rules above.

### C. Risk Factor Portfolio Construction

After selecting the k factors, we set the optimal (target) portfolio as a combination of the first k factors and avoid the remaining N−k by assigning a weight of zero to them:

gₜ*=[g_{1,t}* . . . g_{k,t}*0 . . . 0]′. (9)

We use four different approaches when weighting the factors:

Equal weighting—All factors receive the same weight:

$${g}_{i , t}^{*} = \frac{1}{k} . \qquad ( 10 )$$

Risk Parity—This construction equalizes the ex-ante risk contribution of each selected risk factor by using factor weights in proportion to the inverse of their standard deviation:

$${g}_{i , t}^{*} ∝ \frac{1}{\sqrt[ ]{var ( {F}_{i , t} )}} . \qquad ( 11 )$$

Notice that this is only an approximation in the more general case of non-diagonal covariance matrices. Nevertheless, since the risk factors are orthogonal, this is the optimal solution in this case.

Mean-variance optimization—In the case of traditional asset allocation, the weights of the portfolio with the highest ex-ante Sharpe ratio are proportional to Σ⁻¹, where μ represents the expected returns of the assets. Since the factors are orthogonal to each other, the formula simplifies and the weights are proportional to:

$${g}_{i , t}^{*} ∝ \frac{E [ {F}_{i , t} ]}{var ( {F}_{i , t} ) } . \qquad ( 12 )$$

Minimum variance—This is a special case of mean-variance optimization and is obtained by assuming that all assets have the same expected return. In traditional asset allocation the weights are proportional to Σ⁻¹·ι, where ι represents a constant vector of ones. The absence of correlation between the factors implies that the factors weights are proportional to:

$${g}_{i , t}^{*} ∝ \frac{1}{var ( {F}_{i , t} ) } . \qquad ( 13 )$$

These weighting heuristics are chosen for their simplicity and because they are very popular among managers and investors in traditional portfolios. Our goal in this paper is not to choose a preferred heuristic, but mainly to show that portfolios based on risk factors consistently outperform their asset-based counterparts irrespective of the heuristic chosen.

The formulas above allow us to identify some of the advantages of asset allocation using a factor-based approach. The main argument to have in mind is that introducing a new asset class into the investment universe is a good strategy only to the extent that it satisfies one—or both—of the following conditions: a) it provides exposure to a new risk factor or b) it significantly enhances the ability of the portfolio to obtain exposure to an existing risk factor.

As a more concrete example, consider introducing new equity indexes into the portfolio. If these new indexes are highly correlated with the existing ones, they could result in undesired side effects. First, the covariance matrix of the assets would become closer to singular, which could cause all sorts of numerical problems in the calculation of its inverse, Σ⁻¹. A PCA-based approach alleviates this concern, because it allows us to identify and fix these problems by ignoring less important factors, setting their weights to zero in gₜ*, and avoiding calculations such as 1/var(F_{i,t}). In fact, one of the most common ways of inverting matrices that are singular, or close to singular, is to use PCA (singular value decomposition, or SVD) and ignore or discard factors (principal components or eigenvectors) with zero, or close to zero, variance (norm). Second, the existence of these new equity indexes by itself tends to cause an overexposure to equities. This effect is observed in its most extreme form with equal weighting, because the weights are mechanically linked to the number of asset classes that have exposure to a particular factor. The factor-based approach, on the other hand, identifies that these new indexes are not bringing much new information and still calculates an equity risk factor very similar to the existing one. Finally, the similarity between the weights of the different factor-based portfolios (and between their simulated performances, presented below) leads us to believe that this is a relatively more robust approach. Unlike the asset-based approach, the factor-based approach doesn't normally observe wildly different weights or performances following small changes in portfolio construction heuristic.

### D. FROM FACTORS TO ASSETS

Ideally one would like to invest in the optimal portfolio:

gₜ*′·Fₜ=gₜ*′·Vₜ′·Mₜ⁻¹·rₜ=wₜ*′rₜ. (14)

However, the weights wₜ* in asset domain might violate some restrictions imposed by managers or investors—positivity is usually the most important one. For this reason, in the last step we search for investable weights, gₜ and wₜ, by minimizing their distance to the optimal weights subject to any necessary constraints:

min_{{g}_{ₜ}_{}}(gₜ−gₜ*)′·Zₜ·(gₜ−gₜ*)s.t. constraints, (15)

where Zₜ is some distance-weighting matrix. Using the relationship between factor and asset weights, gₜ=Vₜ′·Mₜ·wₜ, we obtain an optimization in asset domain:

min_{{w}ₜ}(wₜ−wₜ*)′·Mₜ·Vₜ·Zₜ·Vₜ′·Mₜ·(wₜ−wₜ*)s.t. constraints. (16)

There are a few common options for Zₜ, but we focus on Zₜ=Dₜ⁻¹, sometimes referred to as the Mahalanobis distance. This choice penalizes deviations from the optimal weights in inverse proportion to the volatility of each factor, giving more importance to factors with lower risk and/or higher Sharpe ratio.

### E. Asset Weights Smoothing

We have identified two sources of noise in the factor construction methodology. The first one regards the fact that the PCA is sign-invariant; both Fₜ and −Fₜ have the same variance and are therefore indistinguishable to the procedure. To alleviate this issue, we filter the factors by always choosing the version with a positive average return or cross-sectional risk premium. This simple procedure eliminates the uncertainty in many cases, but a few still remain. (This happens mostly when the factor's average return has a small magnitude and might switch its sign in a few months.)

The second source relates to the sorting procedure. Two or more factors might have very similar values in the sorting criterion and therefore switch positions in the factor ordering. When this causes them to get in or out of the factor investment universe, some turnover is created.

To reduce the turnover caused by the remaining noise that was not filtered out by the method above, we adopt a six-month moving average of the weights.

### III. RESULTS AND DISCUSSION

### A. Factor Interpretation

One of the main criticisms of risk factors obtained by PCA is a lack of economic or intuitive meaning behind them. For this reason, we make an attempt at identifying the risks proxied by each of the factors, before presenting the results from our simulations.

We use the entire sample to calculate a correlation matrix Σ_{T} and then find V_{T} and D_{T} via PCA, as described above. First, we plot each element in the diagonal of D_{T} as a fraction of their sum, var(F_{i,T})/Σᵢ₌₁^{N}var(F_{i,T}). Since the factors are orthogonal and jointly explain all of the variance of the assets, this ratio tells us the percentage contribution of each factor to the total variance in the sample.

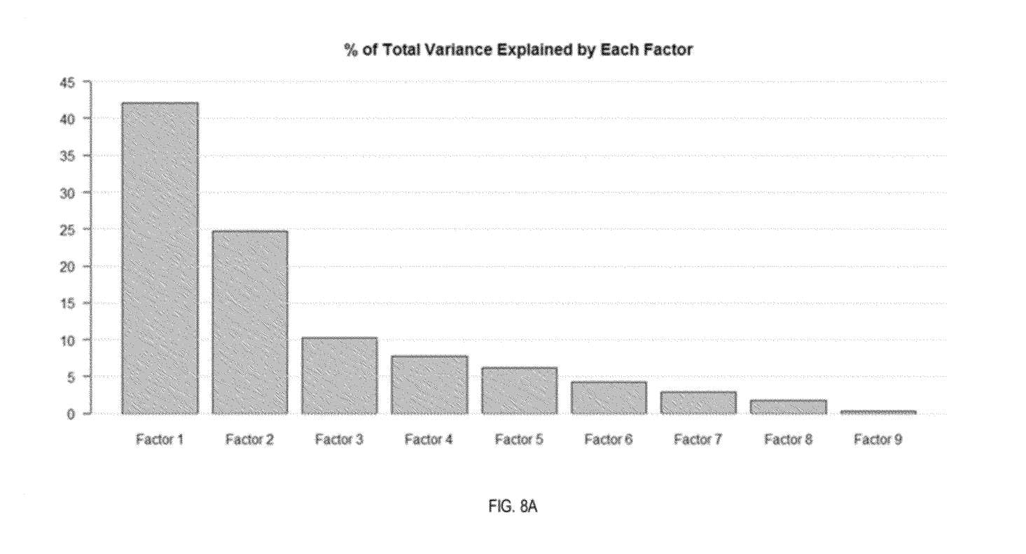

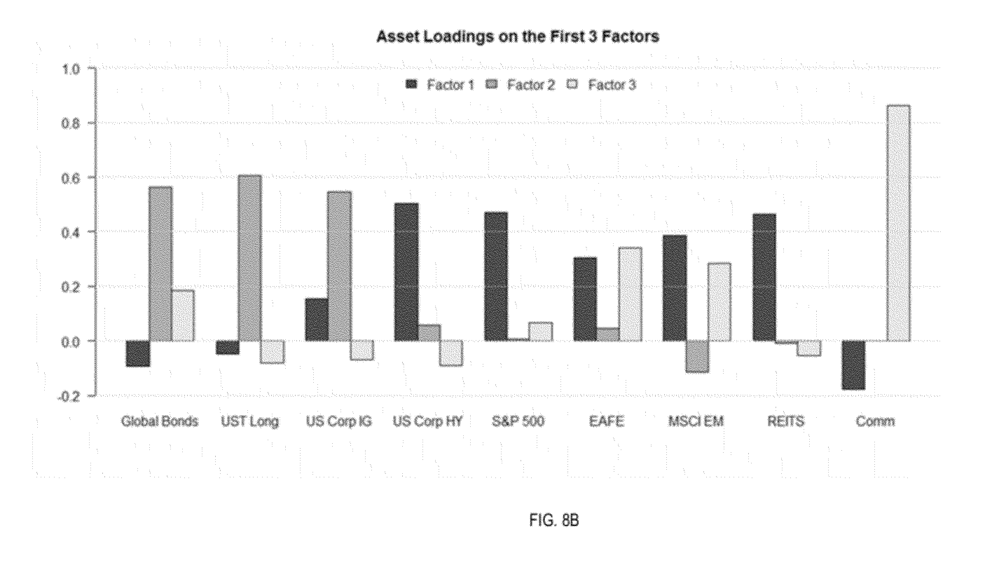

The top plot in FIG. 8A shows that the variance of the first factor accounts for over 40 percent of the total variance, while the second and third ones for 25 and 10 percent, respectively. In other words, one is able to explain over three quarters of the total variance by using just the first three factors. The marginal contribution to total variance decays very rapidly; the incremental role of the last factors is small and they are usually seen as noise or idiosyncratic. Of course, as argued above, variance alone is not the best characteristic to evaluate a factor on. We defer from such an analysis at this point, since our goal here is simply to show that one can identify and provide some intuitive meaning to most factors.

The bottom plot FIG. 8B depicts the loadings (regression coefficients) from each asset on the first three factors. The first one can be interpreted as an equity risk factor, since it influences the three equity indexes, high yield corporate bonds and REITS. The second factor represents interest rate risk, as US Treasuries, global bonds and investment grade corporate bonds depend on it. Finally, the third factor seems to be mostly a commodities risk.

A few interesting conclusions can be derived from the same plot. In hindsight, creating two separate classes for corporate bonds was an important decision, since investment grade and high yield corporate bonds depend mostly on different types of risk: the first one responds to movements in interest rates while the second one follows equity markets more closely. EAFE and emerging markets stock indexes have significant loadings on the third factor, due either to their dependence on commodities exports and imports or indirectly through inflation, for instance. Surprisingly, REITs show a high correlation with equity markets and almost no exposure to interest rates.

This analysis shows that identifying the risks proxied by each factor requires a certain degree of subjectivity. Nonetheless, in most cases the results are intuitive and sometimes even enhance our understanding about risk exposures of traditional or alternative asset classes.

### B. Simulations

As described above, our framework is flexible enough to accept different allocation strategies. We do not favor one over the others, but instead compare the performance of each methodology under two different approaches: a benchmark using traditional asset allocation and the risk factor-based allocation proposed here. We choose four heuristics that are simple to implement and are widely used in practice: equal weighting, risk parity, minimum variance and mean-variance optimization.

The sample is 30 years long and we use monthly returns for nine asset classes: long term Treasuries, investment grade U.S. corporate bonds and high yield U.S. corporate bonds are from Barclays Capital Live (http://live.barcap.com); global government bonds are from Global Financial Data (http://www.globalfinancialdata.com) and from Bloomberg; S&P 500 Index is from Global Financial Data; MSCI EM and MSCI EAFE total return indexes are from MSCI (http://www.mscibarra.com); FTSE NAREIT returns are from http://reit.com; and the Dow Jones-AIG Commodity Index is from Global Financial Data. The risk free rate is proxied by three-month T-Bills, obtained from the St. Louis Fed (http://research.stlouisfed.org/fred2/).

When selecting the few parameters necessary to simulate the performance of the different allocation strategies, we try to find a balance between the available options. Reporting results for all combinations would be outside the scope of this paper, so we justify our choices as best as we can.

Short selling is not allowed and all simulations are out-of-sample, i.e., only information up to month t is used when calculating the weights applied to returns in month t+1. Given that the number of assets, N, is equal to 9, the strategies require a maximum of 54 parameters-9 expected returns plus N·(N+1)/2=45 elements in the covariance matrix. (Some strategies need only a subset of that.) For this reason we choose rolling windows of length 5 years (60 months) for estimation. Rebalancing is done at the end of each quarter; monthly adjustments create too much turnover, even for some benchmarks, whereas annual changes would likely hinder the timing ability of some strategies.

Tables 8, 9, 10 and 11—one for each strategy—have the same structure. The first row contains information about the benchmark, rₜ^{b}, which is calculated using traditional asset allocation. The next two groups of rows, “Factor Sharpe Ratio” and “Factor Risk Premium,” present the results for the risk factor-based portfolios, rₜ. Each of these two groups uses a different sorting criterion for the risk factors, as explained above, and is further divided into four rows, numbered from 1 through 4 according to the number of factors used in the strategy.

The first group of columns, denoted “Absolute Performance,” reports annualized average return in excess of the T-bill, E[rₜ^{b}−rₜ^{f}] and E[rₜ−rₜ^{f}], standard deviation, σ(rₜ^{b}) and σ(rₜ), and Sharpe ratio, E[rₜ^{b}−rₜ^{f}]/σ(rₜ^{b}) and E[rₜ−rₜ^{f}]/σ(rₜ), for both the benchmark and the factor-based portfolios. The second group of columns, “Relative Performance,” presents similar statistics but relative to the asset-based benchmark: active return, E[rₜ−rₜ^{b}], tracking error, σ(rₜ−rₜ^{b}), and Information ratio, E[rₜ−rₜ^{b}]/σ(rₜ−rₜ^{b}). Note that we do not report t-statistics for excess returns or active returns. Those can be calculated by multiplying the Sharpe or Information ratios by the square root of the number of years in our sample:

$$t = \frac{E [ {r}_{t} - {r}_{t}^{f} ]}{σ ( {r}_{t}^{b} )} \cdot \sqrt{T} and t = \frac{E [ {r}_{t} - {r}_{t}^{b} ]}{σ ( {r}_{t} - {r}_{t}^{b} )} \cdot \sqrt{T} . \qquad ( 17 )$$

Given that T=30 years, t-statistics of 2 for excess or active returns correspond to Sharpe or Information ratios of approximately 0.36. Finally, the third column reports the average quarterly turnover of each strategy.

We start our discussion with the equal weighting portfolios in Table 8. The asset-based benchmark has a Sharpe ratio of 0.48 and unsurprisingly low turnover at 2%. The factor-based portfolios have similar or better absolute performance, with some Sharpe ratios as high as 0.58. The bottom portfolios, which sort the factors according to their estimated risk premiums, provide slightly better results, but with relatively higher turnover.

However, Sharpe ratios are likely not the best comparison metric, as leverage is required by low volatility portfolios. For this reason, we also compare the risk factor-based portfolios with their asset-based benchmark using the Information ratio. This metric shows a clear disadvantage for the portfolios sorted on “Factor Sharpe Ratio” in Table 8. Notice that the excess return of the benchmark is higher than the excess returns of all four portfolios, yielding negative Information ratios. The “Factor Risk Premium” portfolios, on the other hand, have positive Information ratios as high as 0.41 in the case of 2 risk factors.

Table 9 reports the results for the second strategy: minimum variance. The benchmark delivers on its promise and presents the lowest standard deviation of all portfolios studied here, 6.53%, but its Sharpe ratio is not very attractive at 0.16. The risk factor-based portfolios have impressive performance, both in terms of Sharpe and Information ratios. As in the previous table, portfolios that use 2 or 3 risk factors seem to be the best choices.

Tables 10 and 11, which present the results for mean-variance and risk parity portfolios, have similar characteristics. The asset-based mean-variance and risk parity portfolios have Sharpe ratios of 0.43 and 0.50. Risk parity achieves its Sharpe ratio with low volatility, as is usually the case. In most cases the risk factor-based portfolios outperform their benchmarks in terms of Sharpe and Information ratios. The “Factor Risk Premium” portfolios present relatively better results, but at the cost of higher turnover.

As a general pattern across the four tables, we report better performance by the risk factor-based portfolios, in particular by those that use 2 or 3 factors only. As discussed in the previous section, the first two or three factors explain a large fraction of the total sample variance. However, our methodology chooses the factors based on their risk adjusted past or expected performance: Sharpe ratio or risk premium. Choosing the factors based solely on the fraction of total variance they explain results in slightly worse performance (not reported here).

Finally, the results presented here are not necessarily indicative of future performance. Neither do we claim that our simulations hold in every sample universe or period. Nonetheless, the theoretical foundations of our methodology make us believe that it provides an interesting alternative to traditional allocation strategies, and that it is a significant first step towards an approach that relies more on risk factors and less on individual assets.

### IV. CONCLUSION

Traditional asset allocation is heavily focused on the assets' characteristics. This paper argues that an approach based on risk factors would be an interesting alternative. We develop a methodology that uses only information about the asset classes, but allocates the funds according to the risk factors underneath them.

Our methodology may include of four exemplary steps. First, the risk factors are found using Principal Component Analysis, or PCA. Second, we sort the risk factors according to two measures of how attractive they are in terms of risk adjusted returns. Third, an allocation strategy or heuristic is used to select the weights associated with each risk factor. Fourth, the risk factor portfolio is translated into an asset portfolio.

We believe this approach is an important first step towards having a framework that favors more the risk factors and less the assets. As a case study, we apply our methodology to a sample with nine asset classes spanning roughly 30 years. The results are promising. We compare the performance of four broadly used asset allocation strategies equal weighting, mean-variance optimization, minimum variance portfolio and risk parity and report a consistent outperformance by the risk factor-based versions relative to their asset-based benchmarks.

TABLE 7
Risk Contribution Example, 1980-2010

| | | | Bar Cap |
|---|---|---|---|
| | | S&P 500 | Agg |
| Asset Characteristics | Ann. Mean | 11.49% | 8.65% |
| | Ann. Std. Dev. | 15.54% | 5.80% |
| | Corr. S&P 500 | 1.00 | 0.21 |
| Traditional 60/40 Portfolio | Asset Weight | 60% | 40% |
| | Asset Risk Contr. | 90% | 10% |
| | Factor Risk Contr. | 95% | 5% |
| Equal-Weight (Asset Risk) | Asset Weight | 27% | 73% |
| Portfolio | Asset Risk Contr. | 50% | 50% |
| | Factor Risk Contr. | 61% | 39% |
| Equal-Weight (Factor Risk) | Asset Weight | 22% | 78% |
| Portfolio | Asset Risk Contr. | 39% | 61% |
| | Factor Risk Contr. | 50% | 50% |

TABLE 8
Comparison Between Asset- and Risk Factor-Based Equal Weighting Portfolios, 1980-2010

| | | Absolute Performance | | | Relative Performance | | | |
|---|---|---|---|---|---|---|---|---|
| | | Excess | Standard | Sharpe | Active | Tracking | Information | |
| | | Return | Deviation | Ratio | Return | Error | Ratio | Turnover |
| Benchmark | EW | 4.30% | 8.93% | 0.48 | | | | 2% |
| Factor | 1 | 3.61% | 7.92% | 0.46 | −0.68% | 4.01% | −0.17 | 7% |
| Sharpe | 2 | 4.17% | 7.51% | 0.55 | −0.13% | 3.43% | −0.04 | 7% |
| Ratio | 3 | 3.82% | 7.55% | 0.51 | −0.48% | 3.64% | −0.13 | 8% |
| | 4 | 3.64% | 7.68% | 0.47 | −0.65% | 3.57% | −0.18 | 6% |
| Factor | 1 | 5.04% | 9.78% | 0.52 | 0.75% | 4.17% | 0.18 | 12% |
| Risk | 2 | 5.66% | 9.69% | 0.58 | 1.36% | 3.29% | 0.41 | 11% |
| Premium | 3 | 5.70% | 10.08% | 0.57 | 1.40% | 3.59% | 0.39 | 11% |
| | 4 | 4.74% | 10.31% | 0.46 | 0.44% | 3.53% | 0.13 | 10% |

TABLE 9
Comparison Between Asset- and Risk Factor-Based Minimum Variance Portfolios, 1980-2010

| | | Absolute Performance | | | Relative Performance | | | |
|---|---|---|---|---|---|---|---|---|
| | | Excess | Standard | Sharpe | Active | Tracking | Information | |
| | | Return | Deviation | Ratio | Return | Error | Ratio | Turnover |
| Benchmark | Min. | 1.03% | 6.53% | 0.16 | | | | 8% |
| | Var. | | | | | | | |
| Factor | 1 | 3.61% | 7.92% | 0.46 | 2.59% | 4.07% | 0.64 | 7% |
| Sharpe | 2 | 4.85% | 7.24% | 0.67 | 3.82% | 4.09% | 0.93 | 9% |
| Ratio | 3 | 4.25% | 7.30% | 0.58 | 3.22% | 3.93% | 0.82 | 8% |
| | 4 | 3.83% | 7.30% | 0.52 | 2.80% | 3.53% | 0.79 | 8% |
| Factor | 1 | 5.04% | 9.78% | 0.52 | 4.02% | 6.68% | 0.60 | 12% |
| Risk | 2 | 6.03% | 10.45% | 0.58 | 5.00% | 7.61% | 0.66 | 12% |
| Premium | 3 | 6.30% | 9.86% | 0.64 | 5.27% | 7.09% | 0.74 | 12% |
| | 4 | 5.36% | 10.20% | 0.53 | 4.34% | 7.21% | 0.60 | 11% |

TABLE 10
Comparison Between Asset- and Risk Factor-Based Mean-Variance Portfolios, 1980-2010

| | | Absolute Performance | | | Relative Performance | | | |
|---|---|---|---|---|---|---|---|---|
| | | Excess | Standard | Sharpe | Active | Tracking | Information | |
| | | Return | Deviation | Ratio | Return | Error | Ratio | Turnover |
| Benchmark | Tangency | 4.11% | 9.52% | 0.43 | | | | 11% |
| Factor | 1 | 3.61% | 7.92% | 0.46 | −0.50% | 5.05% | −0.10 | 7% |
| Sharpe | 2 | 4.68% | 7.22% | 0.65 | 0.57% | 4.83% | 0.12 | 9% |
| Ratio | 3 | 4.27% | 7.30% | 0.58 | 0.16% | 5.10% | 0.03 | 8% |
| | 4 | 3.95% | 7.34% | 0.54 | −0.16% | 5.34% | −0.03 | 6% |
| Factor | 1 | 5.04% | 9.78% | 0.52 | 0.93% | 3.96% | 0.24 | 12% |
| Risk | 2 | 5.46% | 9.18% | 0.59 | 1.35% | 3.93% | 0.34 | 11% |
| Premium | 3 | 5.17% | 9.02% | 0.57 | 1.06% | 3.65% | 0.29 | 12% |
| | 4 | 4.73% | 8.97% | 0.53 | 0.62% | 4.21% | 0.15 | 11% |

TABLE 11
Comparison Between Asset- and Risk Factor-Based Risk Parity Portfolios, 1980-2010

| | | Absolute Performance | | | Relative Performance | | | |
|---|---|---|---|---|---|---|---|---|
| | | Excess | Standard | Sharpe | Active | Tracking | Information | |
| | | Return | Deviation | Ratio | Return | Error | Ratio | Turnover |
| Benchmark | Risk | 3.78% | 7.52% | 0.50 | | | | 2% |
| | Parity | | | | | | | |
| Factor | 1 | 3.61% | 7.92% | 0.46 | −0.17% | 2.65% | −0.06 | 7% |
| Sharpe | 2 | 4.74% | 7.22% | 0.66 | 0.96% | 2.82% | 0.34 | 9% |
| Ratio | 3 | 4.06% | 7.35% | 0.55 | 0.28% | 2.62% | 0.11 | 8% |
| | 4 | 3.64% | 7.40% | 0.49 | −0.14% | 2.31% | −0.06 | 7% |
| Factor | 1 | 5.04% | 9.78% | 0.52 | 1.26% | 4.68% | 0.27 | 12% |
| Risk | 2 | 5.96% | 10.36% | 0.58 | 2.18% | 5.20% | 0.42 | 12% |
| Premium | 3 | 6.06% | 10.06% | 0.60 | 2.28% | 4.91% | 0.47 | 12% |
| | 4 | 5.28% | 10.29% | 0.51 | 1.50% | 4.92% | 0.30 | 11% |

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method of constructing data indicative of an investible risk factor portfolio of financial objects comprising:
constructing, by at least one processor, data indicative of an optimized factor portfolio comprising:
receiving, by the at least one processor, data about a plurality of monthly returns for multiple years for a universe of asset classes;
receiving, by the at least one processor, data about investment returns;
extracting, by the at least one processor, a plurality of orthogonal risk factors, at least one factor characteristic, and an asset class-factor translation matrix by principal component analysis from said data about said universe of asset classes; and
optimizing, by at least one processor, to determine said optimized factor portfolio;
constructing, by the at least one processor, an investible custom mimicking portfolio based on said optimized factor portfolio, and at least one of any portfolio constraints, or any portfolio specifications, comprising rebuilding using said asset class-factor translation matrix and an optimization process based on said investment returns; and
providing data indicative of said custom mimicking investible portfolio.

2. The method of claim 1, wherein said weighting comprises:
weighting, by the at least one processor, by a mathematical inverse of a volatility of said at least one designated factor of said plurality of risk factors to obtain said optimized factor portfolio.

3. The method of claim 1, wherein said weighting comprises:
weighting, by the at least one processor, by a mathematical inverse of a square root of the variance of said at least one designated factor of said plurality of risk factors to obtain said optimal risk factor portfolio.

4. The method of claim 1, further comprising:
constructing, by the at least one computer, an investible custom mimicking portfolio based on said optimized factor portfolio.

5. The method of claim 1, wherein said optimizing further comprises:
optimizing, by the at least one computer, based on attempting to minimize aggregate portfolio risk of said optimized factor portfolio.

6. The method of claim 1, wherein said optimizing further comprises:
optimizing, by the at least one computer, based on at least one of:
weighting by a strategy; or
determining, by the at least one computer, optimal number of factors to describe the principal component analysis risk factors to obtain an optimal descriptive view comprising at least one of:
determining how to order factors,
determining what cut off of number of factors,
determining which factor(s) are designated, or
determining which factor (s) are non-designated.

7. The method of claim 1, wherein said optimizing comprises:
optimizing, by the at least one computer, comprising:
incorporating, by the at least one computer, constraints and/or specifications comprising at least one of:
removing negative weightings; or
minimizing tracking error.

8. The method of claim 1, wherein said principal component analysis comprises at least one of:
decomposing, by the at least one computer, each of said plurality of asset classes into a plurality of underlying risk factors;
determining factor characteristics; or
determining an asset class to factor translation matrix.

9. The method of claim 1, wherein said constructing the investible portfolio further comprises:
applying leverage to the investible custom mimicking portfolio to obtain a leveraged investible portfolio.

10. The method of claim 1, wherein said weighting comprises:
mathematically combining, by the at least one computer, at least one of: said plurality of risk factors, said at least one designated risk factor, or said any nondesignated risk factors.

11. The method of claim 10, wherein said mathematically combining comprises at least one of:
computing an average;
computing a weighted average;
computing a mean; or
calculating a median.

12. The method of claim 1, further comprising:
rebalancing the investible portfolio.

13. The method of claim 12, wherein said rebalancing comprises rebalancing on a periodic basis.

14. The method of claim 13, wherein said rebalancing periodically comprises at least one of:
rebalancing annually;
rebalancing by accounting period;
rebalancing monthly;
rebalancing quarterly; or
rebalancing biannually.

15. The method of claim 12, wherein said rebalancing comprises at least one of:
rebalancing upon reaching a threshold;
rebalancing the investible portfolio as said optimal risk factor portfolio changes over time; or
rebalancing the investible portfolio to match said optimal risk factor portfolio changes over time.

16. The method of claim 1, wherein said weighting comprises:
equally weighting across said at least one designated risk factors according to said optimal risk factor portfolio.

17. The method of claim 16, further comprising:
equally weighting across said any nondesignated risk factors according to said optimal risk factor portfolio.

18. The method of claim 1, wherein said plurality of risk factors comprises at least one of:
designated factors;
nondesignated factors;
a first group of factors; or
a second group of factors.

19. The method of claim 1, further comprising:
tagging each of said plurality of risk factors as at least one of said at least one designated factor, or said any nondesignated factors.

20. The method of claim 1, wherein said weighting comprises:
mathematically combining, by the at least one computer, at least one of: said plurality of risk factors, said at least one designated risk factor, or said any nondesignated risk factors, as said risk factors change over time.

21. The method of claim 20, wherein said mathematically combining comprises at least one of:
computing an average of said risk factors as said risk factors change over time;
computing a weighted average of said risk factors as said risk factors change over time;
computing a mean of said risk factors as said risk factors change over time; or
calculating a median of said risk factors as said risk factors change over time.

22. The method of claim 21, wherein said changes over time comprises changing periodically.

23. The method of claim 22, wherein said changing periodically comprises at least one of:
changing annually;
changing by accounting period;
changing monthly;
changing quarterly; or
changing biannually.

24. The method of claim 6, wherein said weighting comprises:
weighting by risk factor parity for said plurality of risk factors.

25. The method of claim 1, further comprising:
constructing an portfolio of financial objects based on said custom mimicking portfolio.

26. The method of claim 1, further comprising:
applying leverage to the investible portfolio to obtain a final investible risk factor portfolio.

27. The method of claim 1, further comprising: providing investible access to particular risk factors.

28. The method of claim 1, further comprising: constructing quantitatively an asset allocation index.

29. The method of claim 1, wherein said providing comprises: publishing said asset allocation index.

30. The method of claim 1, further comprising:
constructing, by the at least one computer, at least one factor characteristic for each of said plurality of orthogonal risk factors based on said plurality of orthogonal risk factors and data about investment returns comprising data indicative of characteristics comprising at least one of:
a plurality of investment names,
an investment type,
an investment country, or
an investment returns by time periods, to obtain a factor structure and characteristics database.

31. The method of claim 1, further comprising: storing, by the at least one computer, in said factor structure and characteristics database, at least one of said orthogonal factors, said factor characteristics, and said asset class-factor translation matrix.

32. The method of claim 31, wherein said asset class-factor translation matrix comprises at least one of:
a relationship between each asset class to at least one factor;
a relationship of a factor to at least one asset class;
dependencies between the at least one factor and the at least one asset class; or
a relationship between the at least one factor and the at least one asset class.

33. The method of claim 1, wherein said optimizing comprises at least one of:
determining by the output of the factor limitations or factor specifications at least one of a designated or a non-designated, a flagged, or a non-flagged factor;
taking the characteristics,
ranking factors by a characteristic,
specifying a cutoff point (number of factors, or characteristic level),
using the factor characteristics to choose a subset of the factors,
defining a criteria to include as factors in the optimization, and where a factor is included, the included factor gets assigned a weight, and if not included, the factor weight will be set to zero;
defining a first group of one or more factors deemed designated factors, and if the designated factor or factors does not sufficiently meet the criterion, bringing in a minimal additional number of weights to any second group of one or more factors deemed nondesignated factor or factors, and
providing an optimization process in assigning weights to any factors.

34. The method of claim 1, wherein said optimized factor portfolio comprises:
at least one designated risk factor of said plurality of orthogonal risk factors and any minimized nondesignated risk factors of said plurality of orthogonal risk factors for said each of said universe of asset classes, and
an optimized weighting of said at least one designated factor and said any minimized nondesignated factors based on at least one of:
factor limitations,
factor specifications,
factor sort logic,
factor cutoffs,
factor weighting logic, or
factor treatment logic.

35. The method of claim 1, wherein said optimizing comprises:
weighting, by the at least one processor, by said optimized weighting of (optimal set of factors including at least one designated, and any nondesignated factors) at least one of said at least one designated risk factors, or said any minimized nondesignated risk factors to obtain an optimized factor portfolio.

36. The method of claim 1, further comprising at least one of:
specifying asset classes for inclusion in said asset class universe; or
filtering said asset classes for inclusion in said asset class universe.

37. The method of claim 1, wherein said constructing an investible custom mimicking portfolio comprises:
obtaining for the optimized factor portfolio factors and weights, previously selected by the optimized weighting based on the underlying designated and any nondesignated factors,
reducing at least one risk factor and weight associated with it, and at least one of:
any portfolio constraints, or
any portfolio specifications; and
rebuilding an investible portfolio meeting said constraints and specifications, using said asset class-factor translation matrix

38. The method of claim 1, wherein said constructing an investible custom mimicking portfolio comprises wherein said investible custom mimicking portfolio is constructed comprising:
translating said optimized factor portfolio to an investible asset classes that has an optimal or closest fit to the portfolio constraints and/or portfolio specifications.
